(19) United States
(12) Patent Application Publication
(10) Pub. No.: US 2015/0066674 A1
(43) Pub. Date: Mar. 5, 2015

(54) SYSTEMS AND METHODS TO IDENTIFY AND ASSOCIATE RELATED ITEMS

(71) Applicants: Michael Liu, Campbell, CA (US); Ari Shapiro, Discovery Bay, CA (US); Shane Shew Shin Yong, Fremont, CA (US); Syed Raza Hussain, Campbell, CA (US); Vineet Kothari, San Jose, CA (US)

(72) Inventors: Michael Liu, Campbell, CA (US); Ari Shapiro, Discovery Bay, CA (US); Shane Shew Shin Yong, Fremont, CA (US); Syed Raza Hussain, Campbell, CA (US); Vineet Kothari, San Jose, CA (US)

(21) Appl. No.: 14/446,180

(22) Filed: Jul. 29, 2014

Related U.S. Application Data
(60) Provisional application No. 61/872,189, filed on Aug. 30, 2013.

(51) Int. Cl. G06Q 30/06; H04L 29/06; G06F 17/30

(52) U.S. Cl. CPC G06Q 30/0601; G06F 17/30663; G06F 17/30424; G06F 17/3064; H04L 67/42
USPC 705/26.1

(57) ABSTRACT

Systems and methods to identify and associate related items are described. The system receives listing information describing a part that is offered for sale on a network-based marketplace that includes categories. The listing information includes a title and a category. The system stores the listing information in a listing according to the category. The system parses the title of the listing to identify tokens and to identify whether the tokens match a token in parts descriptors that describe parts that are associated with the first category. The system generates scores based on the tokens and the parts descriptors and may select a part type identifier based on the scores. Finally, the system registers the listing with the parts type identifier and associates listing(s) with the listing based on the parts type identifier. For example, the system may associate listings describing parts that are commonly purchased together.

### RELATED APPLICATIONS

This application claims the priority benefits of U.S. Provisional Application No. 61/872,189, filed Aug. 30, 2013 which is incorporated in its entirety by reference.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### BRIEF DESCRIPTION OF DRAWINGS

Various ones of the appended drawings merely illustrate example embodiments of the present invention and cannot be considered as limiting its scope.

FIG. 1A illustrates a system to identify and associate related items, according to an embodiment;

FIG. 1B illustrates a network-based marketplace, according to an embodiment;

FIG. 1C illustrates merchandising modules, according to an embodiment;

FIG. 1D illustrates merchandising tables, according to an embodiment;

FIG. 1E illustrates a system to generate an expansion table, according to an embodiment;

FIG. 1F illustrates a system to generate category part information, according to an embodiment;

FIG. 2A illustrates catalogue information, according to an embodiment;

FIG. 2B illustrates catalogue part information, according to an embodiment;

FIG. 3A illustrates an expansion table, according to an embodiment;

FIG. 3B illustrates a token descriptor, according to an embodiment;

FIG. 4A illustrates category part information, according to an embodiment;

FIG. 4B illustrates parts information, according to an embodiment;

FIG. 5 illustrates a parts descriptor, according to an embodiment;

FIG. 6 illustrates an items table, according to an embodiment;

FIG. 7A illustrates a method to generate category part information, according to an embodiment;

FIG. 7B illustrates a TABLE 1, according to an embodiment, used to generate category part information;

FIG. 8A illustrates a method to identify and associate related items, according to an embodiment;

FIG. 8B illustrates a method to parse a listing, according to an embodiment;

FIG. 8C illustrates a method to generate part type scores, according to an embodiment;

FIG. 8D illustrates a TABLE 2, according to an embodiment, used to select a part type identifier;

FIG. 8E illustrates a method to select a part type identifier, according to an embodiment;

FIG. 9 is a block diagram illustrating an example embodiment of a high-level client-server-based network architecture;

FIG. 10 is a block diagram illustrating an example embodiment of a publication system;

FIG. 11 is a block diagram illustrating tables that are utilized by the publication system, according to an embodiment; and

FIG. 12 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of an embodiment of the inventive subject matter. It will be evident, however, to those skilled in the art, that embodiments of the inventive subject matter may be practiced without these specific details. In general, well-known instruction instances, protocols, structures, and techniques have not been shown in detail.

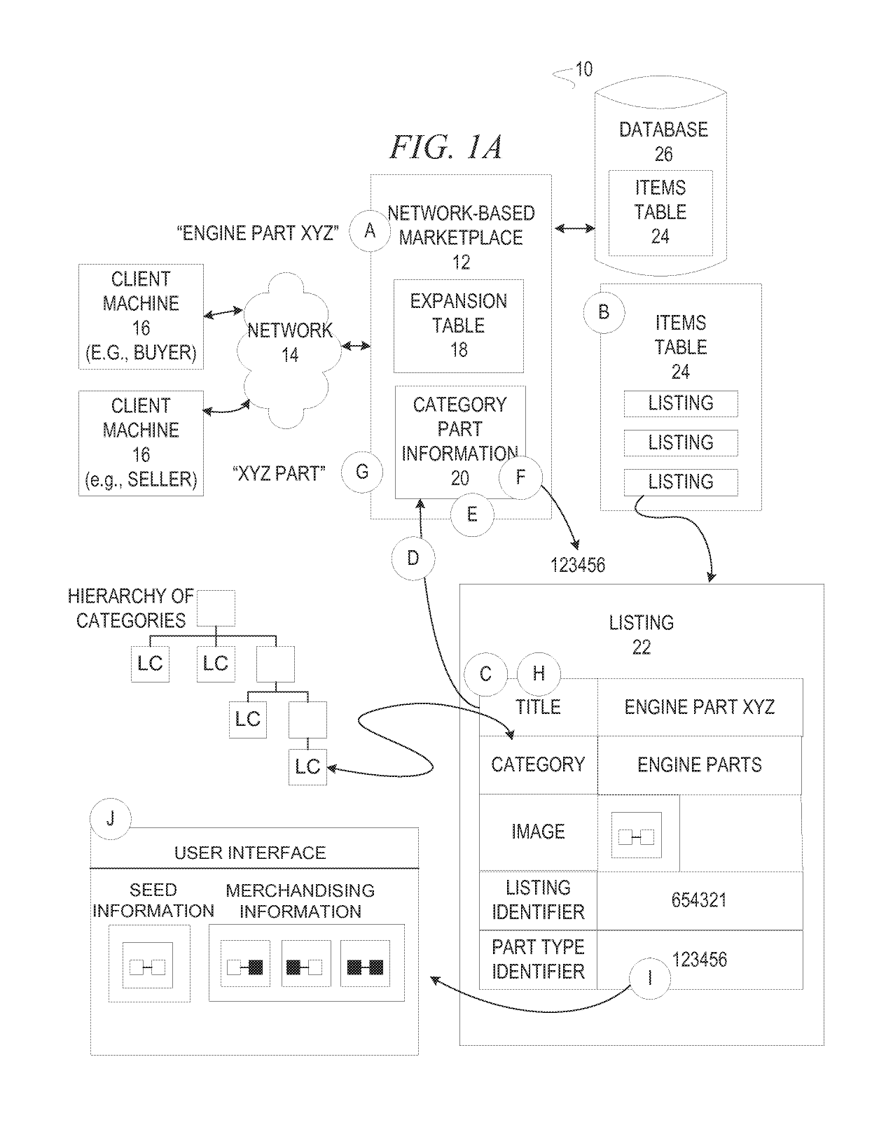

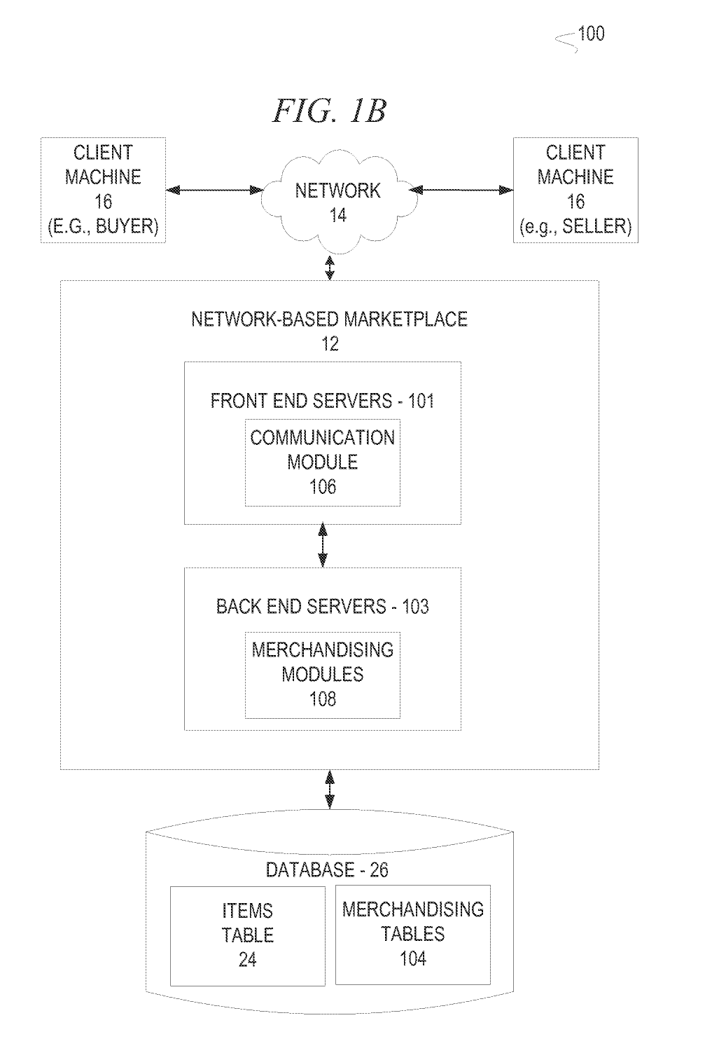

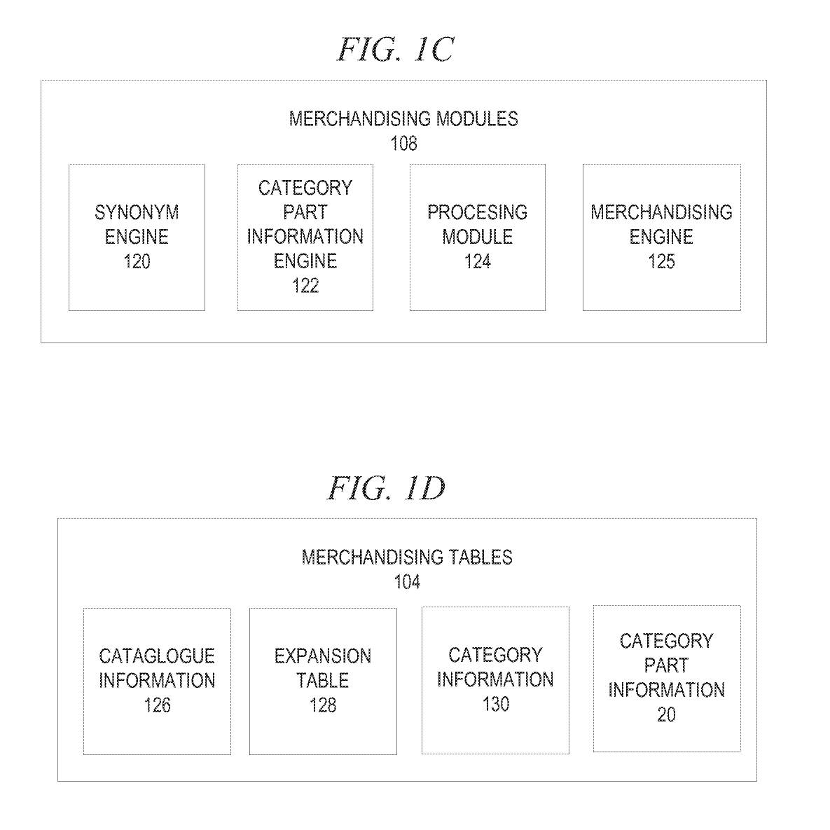

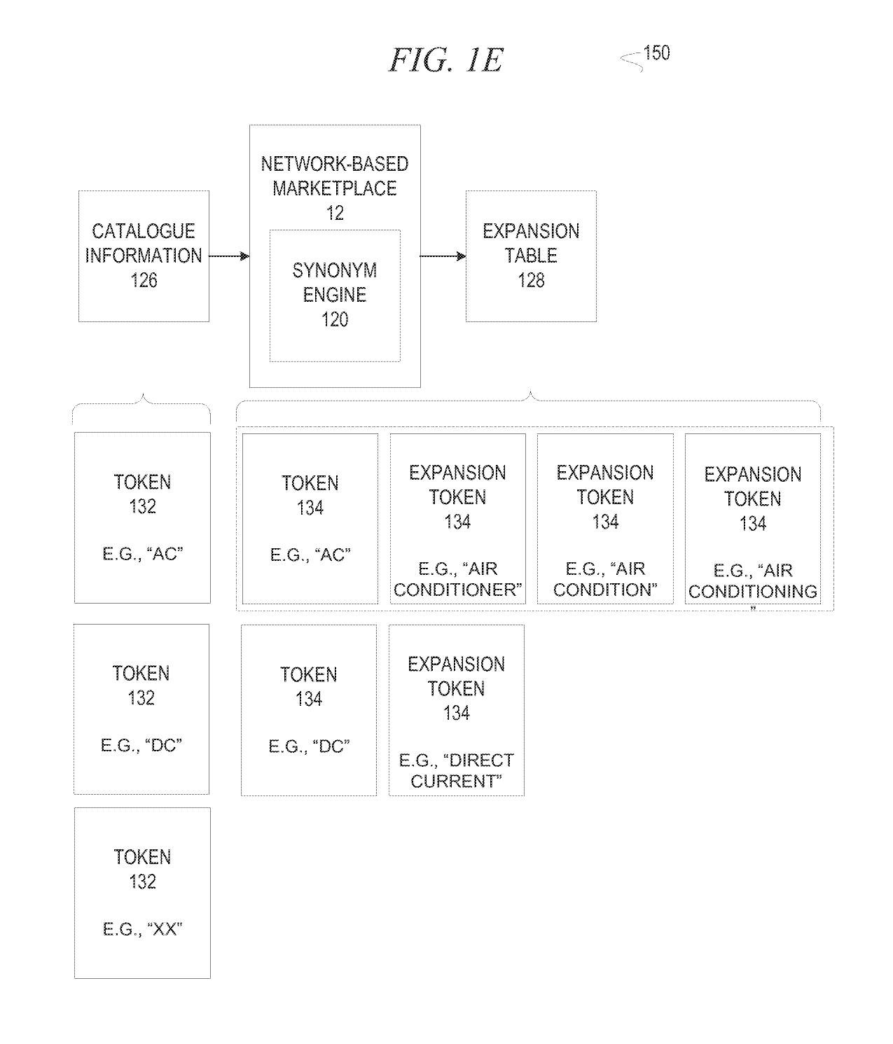

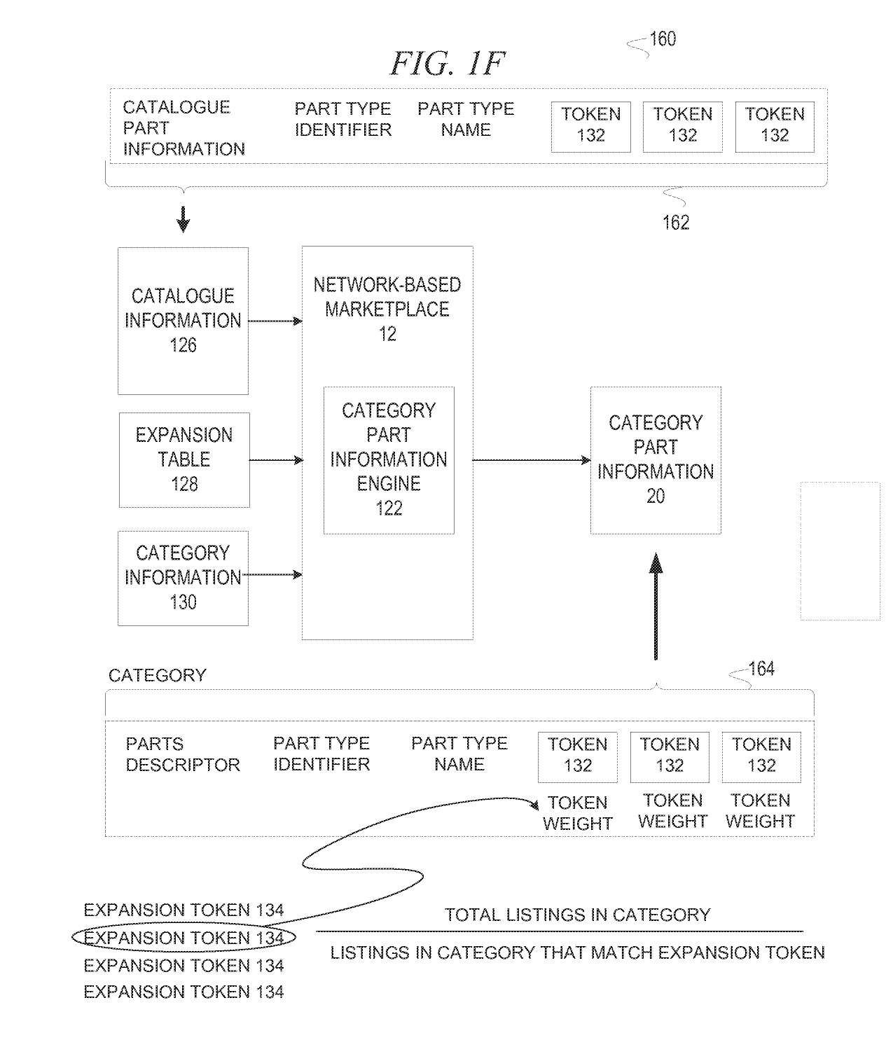

FIG. 1A illustrates a system 10 to identify and associate related items, according to an embodiment. Broadly, the system 10 may include a network-based marketplace 12 that receives listing information from a user (e.g., seller). The listing information may describe an item that is being offered for sale on the network-based marketplace 12 including a title and other elements. In some instances, a seller may provide an item type identifier in the listing information. In other instances the seller may not provide an item type identifier. The network-based marketplace 12 may use the item type identifier to uniquely identify one item from another. For example, WHI of Ry Brook, N.Y. provides a catalogue of automobile parts including part type identifiers that uniquely identify part types. The discussion below is directed at systems and methods including listing information being provided by a seller that describes an item (e.g., part) for an application such as an automobile but without including an item type identifier (e.g., part type identifier). Nevertheless, one having ordinary skill in the art will recognize that the systems and methods described herein are applicable to any type of items that are commonly purchased together (e.g., electronic devices and accessories, clothing, sporting equipment, household appliances, etc.).

Responsive to receipt of listing information at the network-based marketplace 12, the network-based marketplace 12 may store some or all of the listing information in a listing 22 in an items table 24, select a parts type identifier based on the title, and register the listing 22 with a part type identifier by writing the part type identifier into the listing 22. Registering the part type identifier in the listing 22 enables other features. For example, the network-based marketplace 12 may receive a subsequent request from a user (e.g., buyer), identify the listing 22 based on the request, and identify a set of compatible parts that are merchandised as a kit of vehicle parts based on the parts type identifier that was previously registered in the listing 22. The association between identification and association of related parts may be called kitting of vehicle parts, according to an embodiment.

More specifically and according to one embodiment, the system 10 may include the network-based marketplace 12 that, at operation “A,” receives listing information over a network 14 from a client 16 that is being operated by a seller. The listing information may describe a part that is being offered for sale on the network-based marketplace 12. For example, the listing information may include a title (e.g., “ENGINE PART XYZ”) and one or more leaf categories (e.g., “ENGINE PARTS”). The one or more leaf categories may correspond to the lowest level categories (e.g., “LC”) in a hierarchy of categories on the network-based marketplace 12. A leaf category may be nested in a tree of categories and includes listings 22 that describe items that are being offered for sale on the network-based marketplace 12. A user may browse the hierarchy of categories to view listings 22 in the leaf categories of the hierarchy of categories. Responsive to receipt of the listing information, the network-based marketplace 12, at operation “B,” may store all or some of the listing information in the listing 22 in the items table 24 in a database 26 on the network-based marketplace 12. The network-based marketplace 12 may further position the listing 22 in the identified leaf category of the hierarchy of categories to enable browsing. At operation “C.” the network-based marketplace 12 may identify tokens in the title of the listing 22. A token is an atomic object that may include one or more words or letters. For example, the title “ENGINE PART XYZ” may be parsed into one, two (e.g., (“ENGINE PART” and “XYZ”) or (“ENGINE and “PART XYZ”)) or three tokens (e.g., “ENGINE,” “PART,” “XYZ”. A token may be normalized and associated with expansion tokens, as described later in this document. At operation “D,” the network-based marketplace 12 may compare the tokens in the title of the listing 22 with tokens in category part information 20 associated with the category (e.g., “ENGINE PARTS”) in which the listing 22 was positioned by the seller. For example, each leaf category in the hierarchy of categories may be associated with category part information 20 that includes one or more parts descriptors (not shown) that describe part types. Each parts descriptor may include a part type identifier and one or more tokens that are weighted in a pre-processing step based on expansion tokens, as further described in FIG. 1C. Returning to FIG. 1A, the network-based marketplace 12 may compare the tokens in the title of the listing 22 that is illustrated with the tokens in the parts descriptors that are associated with the category in which the listing 22 is positioned to identify matching tokens. For each parts descriptor, the network-based marketplace 12 may compute a score based on the weights that are respectively associated with the tokens included in the parts descriptor that match the title in the listing 22. At operation “E,” the network-based marketplace 12 may select a parts descriptor from the parts descriptors associated with the category based on their respective scores. Other operations may also be used to select the parts descriptor, as described below. At operation “F,” the network-based marketplace 12 may identify a part type identifier in the parts descriptor that was previously selected and register the part type identifier in the listing 22. The part that is described by the listing 22 that is being illustrated is now enabled for kitting with other parts.

At operation “G,” the network-based marketplace 12 may receive a request from a user (e.g., buyer) who is operating a client machine 16, the request including the query “XYZ PART.” For example, the user may be searching for engine parts for installation in an automobile. At operation “H,” the network-based marketplace 12 may identify the listing 22 that is being illustrated in FIG. 1A by matching the keywords in the query with the tokens that were identified based on the keywords in the title of the listing 22. At operation “I,” the network-based marketplace 12 may associate the part type identifier in the listing 22 with part type identifiers in other listings 22. For example, the network-based marketplace 12 may invoke a merchandising engine 125 (as shown in FIG. 1C) with the part type identifier in the listing 22 and the merchandising engine 125 may return a set of listing identifiers that identify listings 22 that include part type identifiers that identify part types that are compatible. At operation “J,” the network-based marketplace 12 may generate and communicate a user interface over the network 14 to the client machine 16. The user interface may include kitting information including a kit or set of vehicle parts (e.g., “MERCHANDISING INFORMATON”) that were identified based on part type identifiers that are compatible with the part type identifier that was identified (e.g., “SEED INFORMATON”). It will be appreciated by one of ordinary skill that while the present disclosure is primarily with reference to the kitting/merchandising of vehicle parts that are commonly purchased together that the systems and methods described herein may also find application to other sets of items commonly purchased together (e.g., electronic devices and accessories, clothing, sporting equipment, household appliances, etc.).

FIG. 1B illustrates a networked system 100, according to an embodiment. The networked system 100 corresponds to the system 10 in FIG. 1A, accordingly, the same or similar references have been used to indicate the same or similar features unless otherwise indicated. The networked system 100 may include a network-based marketplace 12 identify and associate related items (e.g., kitting vehicle parts). The network-based marketplace 12 may include front end servers 101 and back end servers 103. The front end servers 101 may include a communication module 106 and the back end servers 103 may include merchandising modules 108. The database 26 may include the items table 24 and merchandising tables 104. Broadly, the client machines 16 may communicate requests over the network 14 to the network-based marketplace 12 where the requests are received by the communications module 106 that, in turn, communicates the requests to the merchandising modules 108 that, in turn, may store data to the database 26 or retrieve data from the database 26 before communicating responses back via the communication module 106 to the client machines 16. For example, a request may be for search results, a publication of a listing 22, or a viewing of a listing 22. The request for search results may include request information including a query and the corresponding response may include search results describing listings 22 that match the query. The request to publish a listing may include request information including listing information and the corresponding response may include a user interface presenting the listing 22. The request to view a listing 22 may include request information including a listing identifier and the corresponding response may include a user interface presenting the listing 22 and merchandising information including a kit of vehicle parts.

FIG. 1C illustrates merchandising modules 108, according to an embodiment. The merchandising modules 108 may facilitate the kitting of vehicle parts. The merchandising modules 108 may include a synonym engine 120, a category part information engine 122, a processing module 124, and a merchandising engine 125. The synonym engine 120 may generate expansion tokens (e.g. “AIR CONDITIONING”) based on tokens (e.g. “AC”). The synonym engine 120 may operate recursively. For example, the synonym engine 120 may generate the expansion token “Air conditioner” based on the token “A.c.” on a first pass. Continuing with the example, the synonym engine 120 may generate the expansion token “Air conditioners” based on the expansion token “Air conditioner” on a second pass. In one embodiment, a level of recursion depth (e.g., number of passes) may be configured. The category part information engine 122 may generate category part information 20 based on catalogue information, the expansion table 18, and category information. The processing module 124 may process requests that are received and generate responses for the requests. The merchandising engine 125 may identify items (e.g., parts) described in listings 22 that are compatible with other items (e.g., parts) that are described by other listings 22.

FIG. 1D illustrates merchandising tables 104, according to an embodiment. The merchandising tables 104 may facilitate the kitting of vehicle parts. The merchandising tables 104 may include catalogue information 126, an expansion table 128, category information 130, and category part information 20. The catalogue information 126 may include records that describe vehicle parts. The catalogue information 126 may be provided by a third party vendor (e.g., WHI). The expansion table 128 may store expansion tokens. The category information 130 may describe a set of categories and their relationships to one another in a hierarchy of categories. The category part information 20 may be utilized to associate part type identifiers with categories, tokens, and their respective weights.

FIG. 1E illustrates a system 150 to generate an expansion table 128, according to an embodiment. The system 150 may include the network-based marketplace 12 that, in turn, includes the synonym engine 120. The synonym engine 120 may receive catalogue information 126 and generate the expansion table 128 based on the catalogue information 126. For example, synonym engine 120 may receive tokens 132 included in the catalogue information 126 and for each token 132, generate a set of expansion tokens 134, and store the token 132 with the corresponding set of expansion tokens 134 in the expansion table 128.

FIG. 1F illustrates a system 160 to generate category part information 20, according to an embodiment. The system 160 may include the network-based marketplace 12 that, in turn, includes the category part information engine 122. The category part information engine 122 may receive the catalogue information 126, the expansion table 128, and the category information 130 and generate category part information 20. The catalogue information 126 may include multiple catalogue part information 162 records. The catalogue part information 162 may include a set of fields, described below, including tokens 132, as previously described. The expansion table 128 and the category information 130 were previously described. The category part information 20 may include multiple elements of parts descriptors 164 for each category in the hierarchy of categories. The parts descriptor 164 may include a set of fields, described below, including tokens 132, as previously described. It will be observed that the catalogue part information 162 closely resembles the parts descriptor 164 with the exception of a token weight being associated with each token 132. The category part information engine 122 may associate a catalogue part information 162 record with one or more categories, generate a parts descriptor 164 based on the catalogue part information 162 record and compute token weights for each of the tokens 132 in the catalogue part information 162 record, as described later in this document. Broadly, for a single token 132, the category part information engine 122 may identify the number of listings 22 in the category, identify the expansion tokens 134 associated with the token 132, search the listings 22 in the category based on each expansion token 134 to identify a number of matches, compute a weight for each expansion token 134 by dividing the total listings 22 in the category with the number of listings 22 in the category that match the expansion token 134 to generate a set of expansion quotients, select the greatest expansion quotient, and store the greatest expansion quotient as the token weight in the parts descriptor 164. Accordingly, the token weight is inversely related to the matches and directly related to the number of the listings 22 in the category. That is, fewer matches correspond to higher weights. Further, more listings 22 correspond to higher weights. The category part information engine 122 may iterate the above described process for all catalogue part information 162 records to generate a set of parts descriptors 164 that are stored as category part information 20.

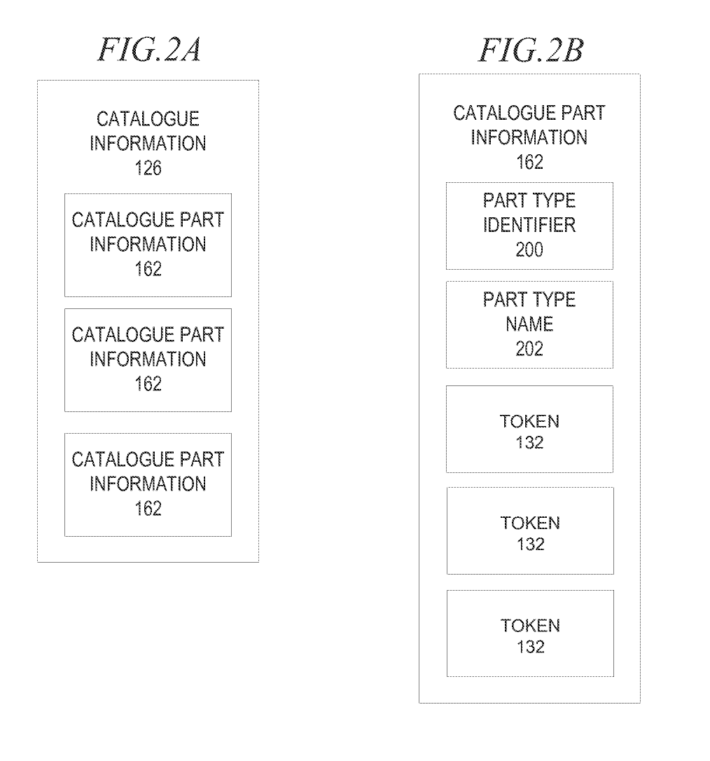

FIG. 2A illustrates catalogue information 126, according to an embodiment. The catalogue information 126 may include one or more catalogue part information 162 records. The catalogue information 126 may be provided by a third party vendor (e.g., WHI), according to an embodiment. FIG. 2B illustrates catalogue part information 162, according to an embodiment. The catalogue part information 162 may include a part type identifier 200 that uniquely identifies a part type, a part type name of the part type, and one or more tokens 132.

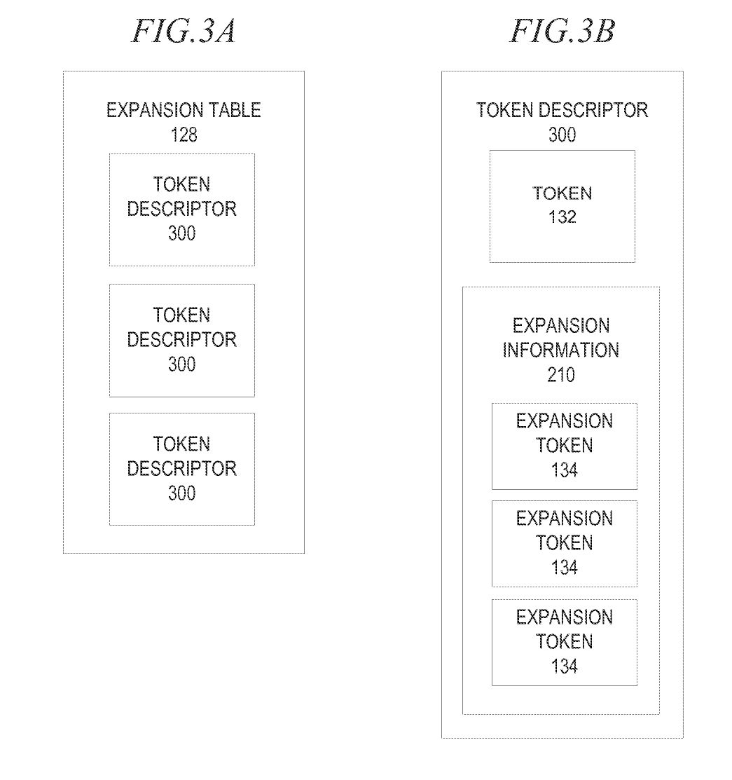

FIG. 3A illustrates an expansion table 128, according to an embodiment. The expansion table 128 may include multiple token descriptors 300. The expansion table 128 may be used to expand tokens 132. For example, queries, titles, and other software constructs that are identified as including an expansion token 134 are further identified as matching the token 132 that corresponds to the expansion token 134. FIG. 3B illustrates the token descriptor 300, according to an embodiment. The token descriptor 300 may be used to associate a token 132 with one or more expansion tokens 134. The token descriptor 300 may include the token 132, as previously described and an expansion information 210 entry including one or more expansion tokens 134.

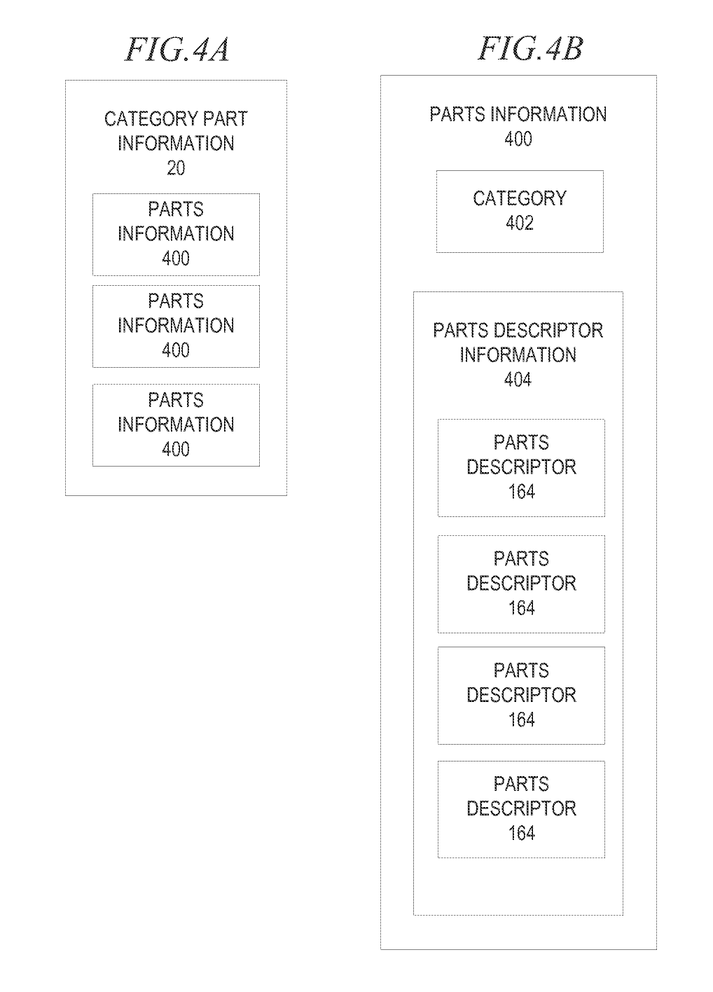

FIG. 4A illustrates category part information 20, according to an embodiment. The category part information 20 may be generated by the category part information engine 122, as previously described in accordance with the system illustrated in FIG. 1F. Returning to FIG. 4A, the category part information 20 may include one or more parts information 400 elements. FIG. 4B illustrates parts information 400, according to an embodiment. The parts information 400 may include category 402 and parts descriptor information 404. The category 402 may be included in the hierarchy of categories, as previously described. The parts descriptor information 404 may include one or more parts descriptors 164 that respectively describe a part type.

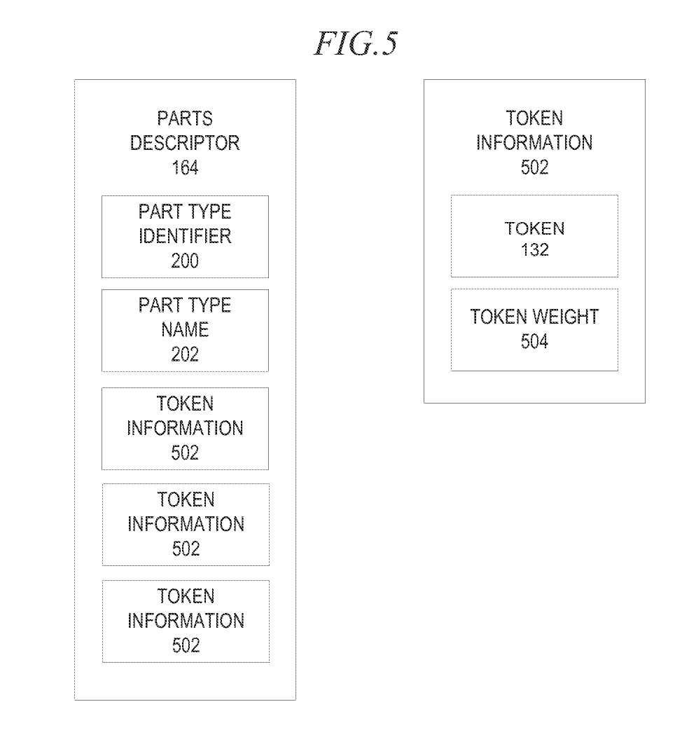

FIG. 5 illustrates a parts descriptor 164, according to an embodiment. The parts descriptor 164 may include a part type identifier 200, a part type name 202 and one or more token information 502 elements that respectively include a token 132 with an associated token weight 504. The part type identifier 200 may uniquely identify a part type. The network-based marketplace 12 may use the part type identifier 200 to uniquely identify one part type from another. For example, WHI of Ry Brook, N.Y. may provide a catalogue of automobile parts including the part type identifier 200, the part type name 202, and the one or more tokens 132. The part type name 202 is the name for the part type. The token information 502 may include the token 132 and the token weight 504 for the token 132 as computed by the category part information engine 122.

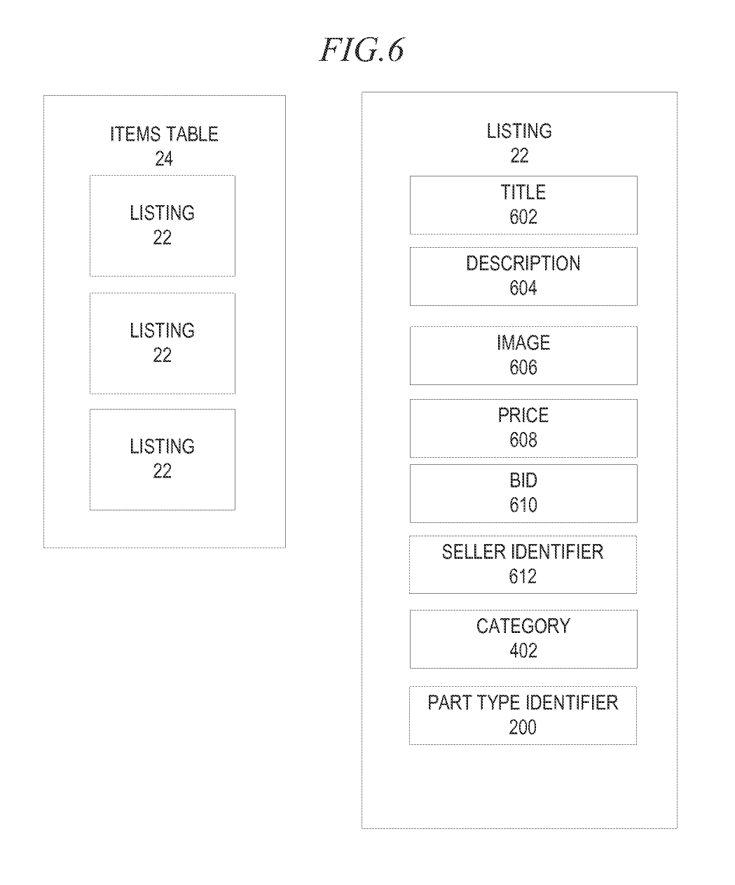

FIG. 6 illustrates the items table 24 according to an embodiment. The items table 24 may include listings 22 describing the items that are published on the network-based marketplace 12. The listing 22 may describe an item that is being offered for sale on the network-based marketplace 12. The listing 22 may include a title 602, a description 604, an image 606, a price 608, a bid 610, a seller identifier 612, one or more categories 402 and the part type identifier 200. The title 602, image 606, one or more categories 402 and part type identifier 200 were previously described. The description 604 may describe the item that is being offered for sale, as received from the seller in the listing information. The price 608 may be the cost to a buyer to immediately purchase the item. The bid 610 may be the current highest bid 610 for the item in an active auction. The seller identifier 612 may identify the seller that is offering the item for sale.

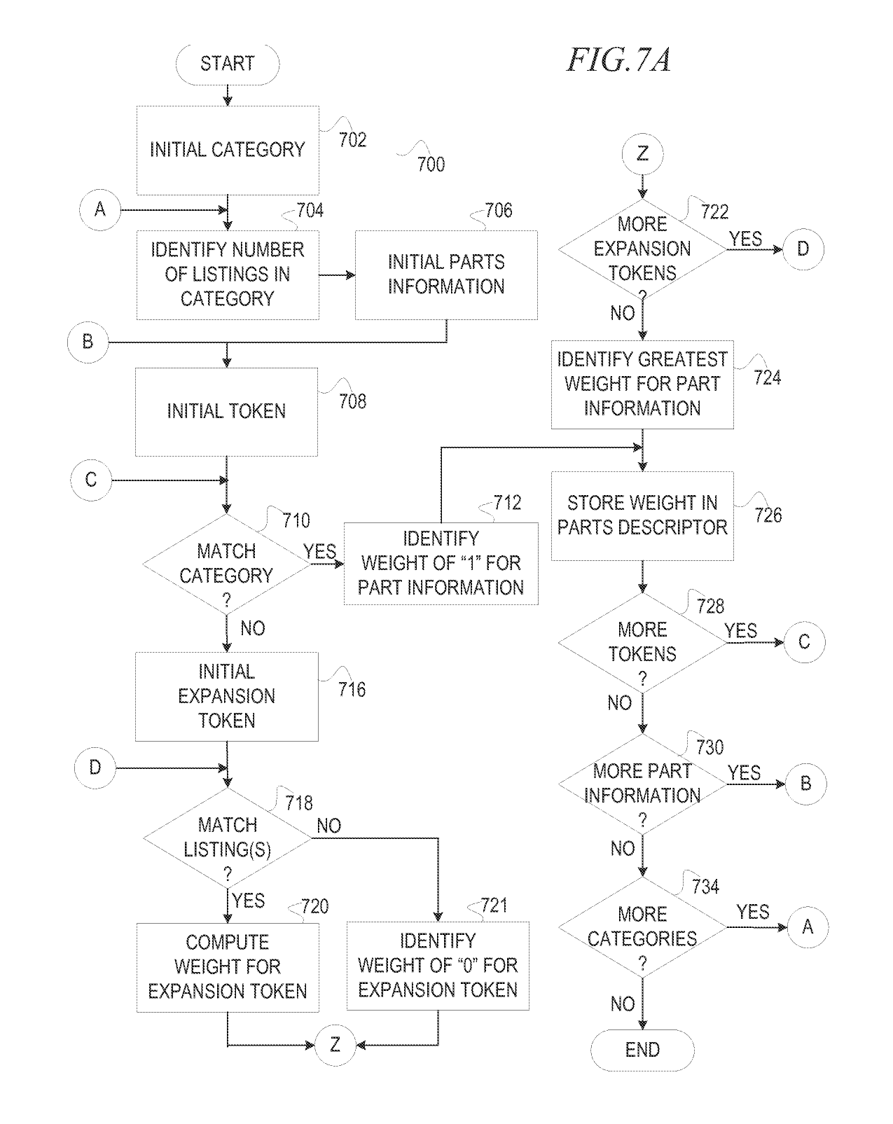

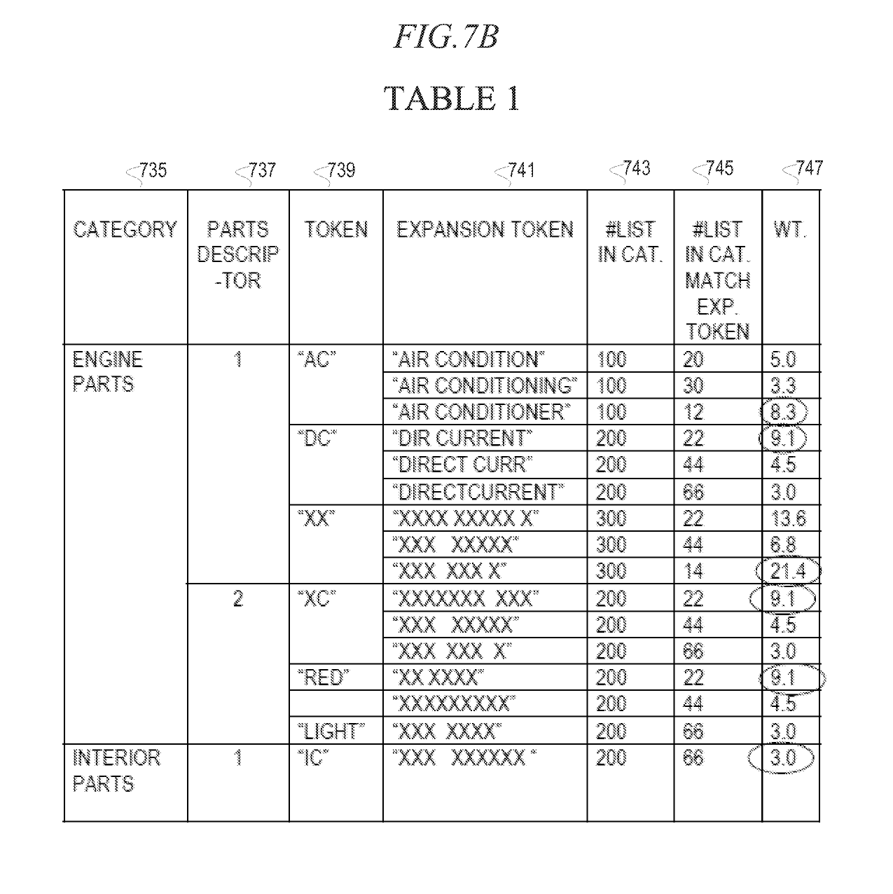

FIG. 7A illustrates a method 700 to generate category part information 20, according to an embodiment. The method 700 may be utilized to generate the category part information 20 based on the catalogue information 126, the expansion table 128 and the category information 130, as previously described in FIG. 1F. Recall that the category information 130 describes the hierarchy of categories for the network-based marketplace 12. The method 700 may commence at operation 702 with the category part information engine 122 identifying the initial category 402 in the category information 130. For example, the category part information engine 122 may identify the category 402 “ENGINE PARTS.” At operation 704, category part information engine 122 may identify and generate a count of the number of listings 22 in the current category 402. For example, category part information engine 122 may search the current category 402 with a wildcard “*” to identify every listing 22 in the current category 402 to generate search results and count the listings 22 in the search results. At operation 706, category part information engine 122 may identify the initial catalogue part information 162 in the catalogue information 126. For example, the initial catalogue part information 162 element may describe a part type that includes the engine part “ENGINE PART XYZ.” At operation 708, the category part information engine 122 may identify the initial token 132 (e.g., AC) in the catalogue part information 162. At decision operation 710, the category part information engine 122 may identify whether the current token 132 (e.g., AC) matches all or a portion of the current category 402 (e.g., “ENGINE PARTS”). If the current token 132 matches all or a portion of the current category 402 then a branch is made to operation 712. Otherwise, processing continues at operation 716. At operation 712, the category part information engine 122 may identify a weight of “1” for the current token 132. At operation 716, the category part information engine 122 may identify the initial expansion token 134 (e.g., “AIR CONDITION”) in the current catalogue part information 162. At decision operation 718, the category part information engine 122 may identify whether the current expansion token 134 (e.g., “AIR CONDITION”) matches any of the listings 22 (e.g., title 602) in the present category, “ENGINE PARTS.” If the current expansion token 134 matches any of the listings 22 then a branch is made to operation 720. Otherwise, processing continues at decision operation 721. At operation 720, the category part information engine 122 may compute a weight for the current expansion token 134 (e.g., “AIR CONDITION”). For example, the category part information engine 122 may compute a weight by dividing the number of listings 22 identified in the current category 402 (e.g., operation 704) by the number of listings 22 that were identified as matching the current expansion token 134 (e.g., decision operation 708). For example, FIG. 7B includes a Table 1 illustrating the described computation in the column marked “WT” signifying weight. As illustrated, the number of listings 22 in the category “ENGINE PARTS,” one-hundred, is divided by the number of listings 22 matching the expansion token 134 “AIR CONDITION,” twenty, to yield the weight of five. At operation 721, the category part information engine 122 may identify a weight of “0” for the current expansion token 134. Returning to FIG. 7A, at decision operation 722, the category part information engine 122 may identify whether the expansion information 210 associated with the current token 132 includes another expansion token 134. For example, the category part information engine 122 may look-up the expansion information 210 in the expansion table 128 based on the current token 132 to identify whether the expansion information 210 includes another expansion token 134. If more expansion tokens 134 are included in the expansion information 210 then the category part information engine 122 advances to the next expansion token 134 before branching to decision operation 718. Otherwise, processing continues at decision operation 724. At operation 724, the category part information engine 122 may identify the greatest of the computed or identified weights (e.g., operations 720, 721, or 712). For example, Table 1 in FIG. 7B illustrates an identification of greatest of computed weights with circles for each catalogue part information 162. Returning to FIG. 7A, at operation 726, the category part information engine 122 may store the identified weight for the current token 132 in a parts descriptor 164, in the descriptor information 404 in the appropriate parts information 400 according to the category 402 that is currently being processed, in the category part information 20. The category part information engine 122 may generate any of the parts descriptor 164, the descriptor information 404, the parts information 400, or the category part information 20. At decision operation 728, the category part information engine 122 may identify whether the catalogue part information 162 includes another token 132. If another token 132 is included then the category part information engine 122 advances to the next token 132 before branching to decision operation 710. Otherwise, processing continues at decision operation 730. At decision operation 730, the category part information engine 122 may identify whether the catalogue information 126 includes another element of catalogue part information 162. If another element is included then the category part information engine 122 advances to the next catalogue part information 162 before branching to operation 708. Otherwise, processing continues at decision operation 734. At decision operation 734, the category part information engine 122 may identify whether the category information 130 in the hierarchy of categories includes another category 402. If another category 402 is included then the category part information engine 122 advances to the next category 402 before branching to operation 704. Otherwise, the method 700 ends.

FIG. 7B illustrates a TABLE 1, according to an embodiment, that is used to generate part information 20 including that parts information 400 including parts descriptor information 404 according to category 402. TABLE 1 may include columns 735, 737, 739, 741, 743, 745, and 747. The column 735 may correspond to the category 402, the column 737 may correspond to the parts descriptor 164, the column 739 may correspond to the token 132, the column 741 may correspond to the expansion token 134, the column 743 may correspond to the number of listings 22 identified in the associated category 402, the column 745 may correspond to the number of listings 22 that match the associated expansion token 134 in the associated category 402, and the column 747 may correspond to a computed weight (e.g., “WT.”) from which the token weight 504 (e.g. circled) may be selected for each token 132 (e.g., see operation 726 in FIG. 7A.

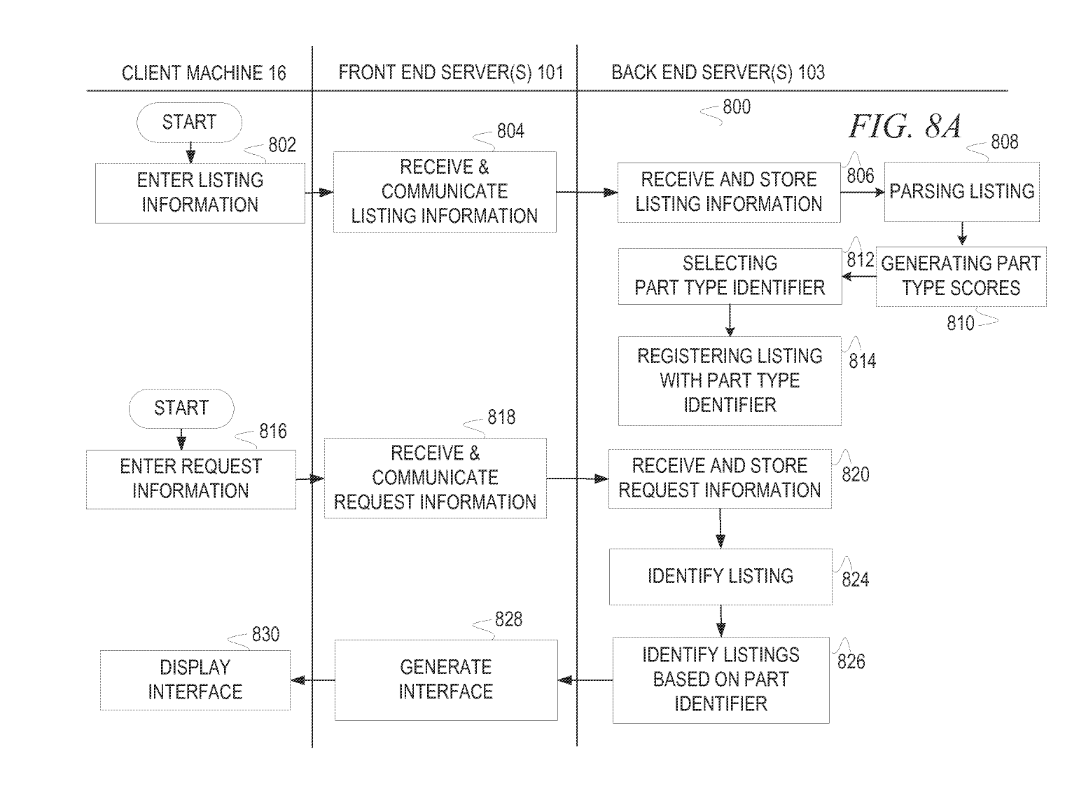

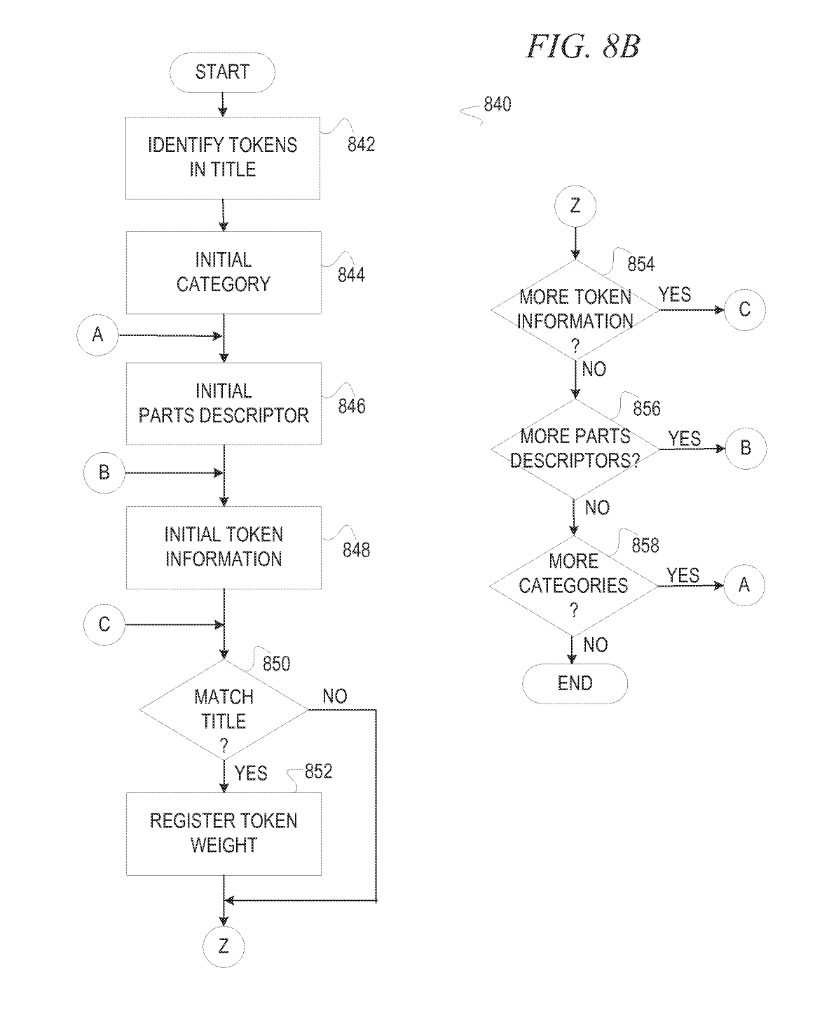

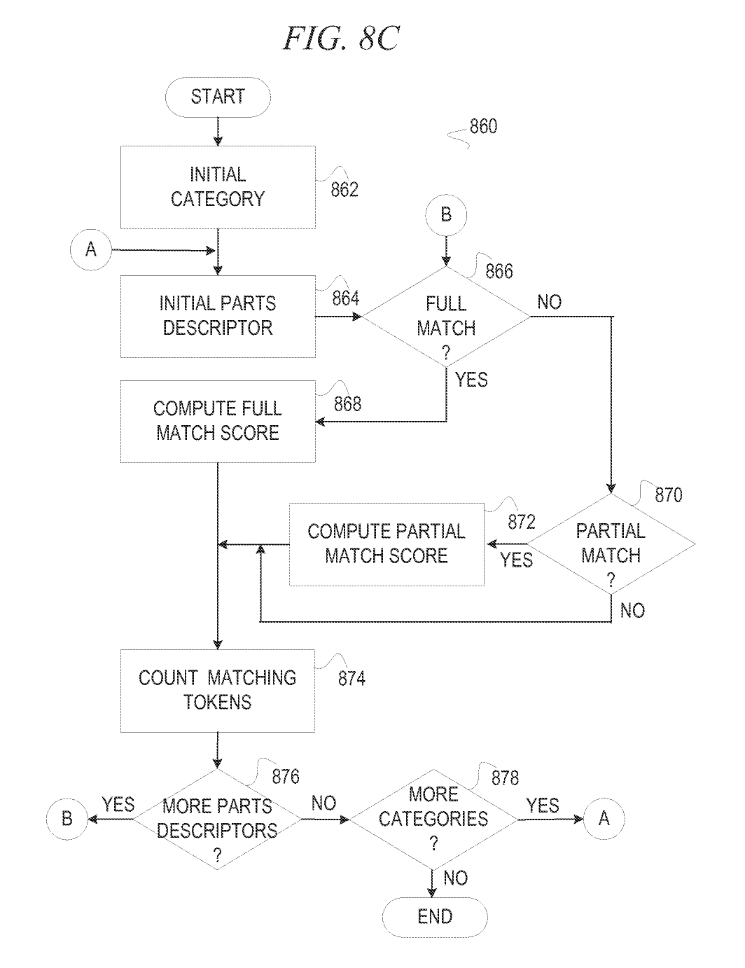

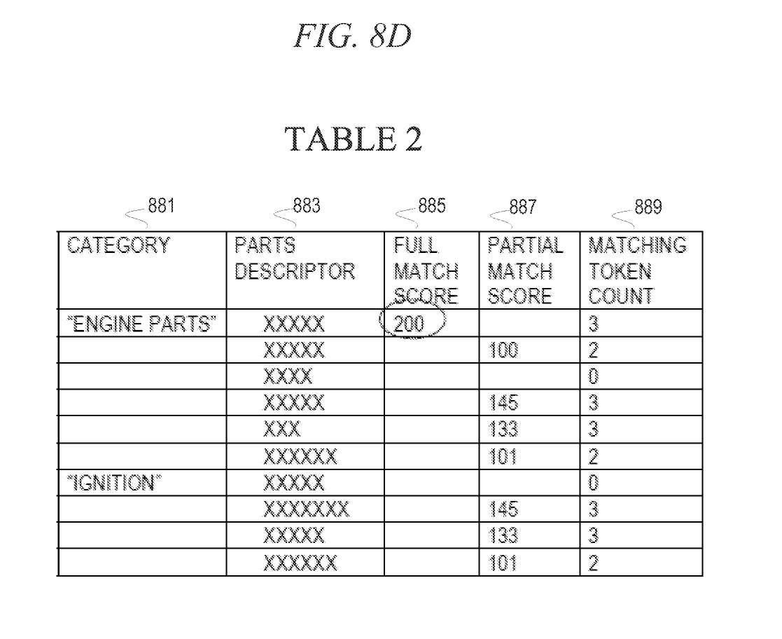

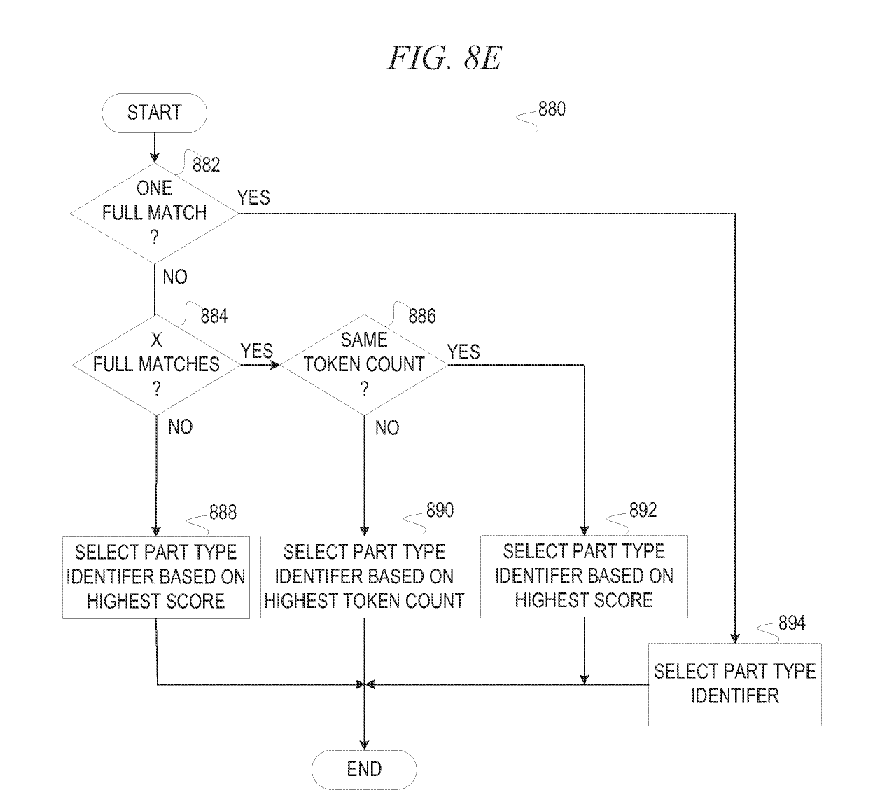

FIG. 8A illustrates a method 800, according to an embodiment, to identify and associate related items (e.g., for kitting vehicle parts). Illustrated on the left are operations performed by the client machine 16, illustrated in the middle are operations performed by the front end servers 101 on the network-based marketplace 12, and illustrated on the right are operations performed by the back end servers 103 on the network-based marketplace 12. The method 800 may commence at operation 802 with the client machine 16 communicating a request to the network-based marketplace 12. The request may be to publish a listing 22. The request may include listing information including a title 602, one or more categories 402 and other elements for publication in the listing 22.

At operation 804, at the front end server(s) 101, the communication module 106 may receive the request and communicate the request to the back end servers 103. At operation 806, at the back end server(s) 103, the merchandising modules 108 may receive and store the request and the listing information. For example, the processing module 124 may store the request in temporary storage and a portion or all of the listing information in the items table 24 as a listing 22. Further, the processing module 124 may register the listing 22 in one or more categories 402 in the hierarchy of categories based on the one or more categories 402 in the listing information. At operation 808, the processing module 124 may parse the title 602 in the listing 22 to identify one or more tokens 132 in the title 602 and, further, to compare the one or more tokens 132 in the title 602 of the listing 22 with the tokens 132 and corresponding expansion tokens 134 in one or more parts descriptors 164 to identify matches, as described further in FIG. 8B. At operation 810, the processing module 124 may generate part type scores based on the matched tokens 132 and corresponding expansion tokens 134, as described further in FIG. 8B. At operation 812, the processing module 124 may select the part type identifier 200 based on the part type scores and or other one or more criterion, as described further in FIG. 8C. For example, the processing module 124 may select the part type identifier 200 that is associated with the highest score. At operation 814, the processing module 124 may register the part type identifier 200 that was selected in the listing 22. For example, the processing module 124 may a store part type identifier 200 in the listing 22.

At operation 816, a user may enter request information that identifies a listing 22 and a request that is communicated over a network 14 to the network-based marketplace 12. For example, a seller may enter a selection that identifies a listing 22 and a request to view, purchase, or monitor of the item that is described by the listing 22. The listing 22 may describe an item that may be a part or component (e.g., engine part) of an application (e.g., vehicle) that is described by application information that is further included in the request information. For example, the application information may include a year, make, and model of a vehicle (e.g., automobile).

At operation 818, at the front end servers 101, the communication module 106 may receive the request information and communicate the request information to the back end servers 103. At operation 820, the processing module 124 may receive and store the request information. At operation 824, the processing module 124 may identify the listing 22 based on the request information. For example, the request information may include a listing identifier that is used to identify the listing 22. At operation 826, the processing module 124 may identify one or more listings 22 (e.g., compatible listings 22) that describe parts that are compatible. For example, parts that are identified as compatible may be parts that are frequently identified as being bought together. The processing module 124 may identify compatible parts based on the part type identifier 200 in the listing 22 that was identified with the request information (e.g., request listing 22), the part type identifiers 200 in other listings 22 in the items table 24, and a merchandising engine 125. For example, the processing module 124 may invoke the merchandising engine 125 with a listing identifier that identifies the request listing 22 (including the part type identifier 200 and the seller identifier 612) and the merchandising engine 125 may return a set of listing identifiers that identify listings 22 that are designated as compatible listings 22 because they describe compatible parts. In one embodiment, the merchandising engine 125 may identify the compatible listings 22 as those listings 22 that include part type identifiers 200 that match the part type identifier 200 in the request listing 22. In other embodiments the merchandising engine 125 may identify compatible listings 22 based on a kitting file that associates part type identifiers 200 that are compatible (e.g., frequently bought together). For example, the kitting file may associated one or more part type identifiers 200 to a particular part type identifier 200 and the merchandising engine 125 identifies the compatible listings 22 based on part type identifiers 200 that are identified as compatible. In one embodiment, the part type identifiers 200 that are identified as compatible may be ranked with a part type identifier score. In one embodiment, the merchandising engine 125 may return a predetermined number of the top ranked part type identifiers 200 (e.g., highest scores) that are compatible. For example, the merchandising engine 125 may return the top ranked four part type identifiers 200 that are compatible. In one embodiment, the merchandising engine 125 may return part type identifiers 200 that are filtered based on the application information received in the request information. For example, the merchandising engine 125 may filter out listings 22 with part type identifiers 200 that are not compatible with the application information (e.g., year, make and model of a vehicle) to return part type identifiers 200 that are compatible with the application information. In one embodiment, the merchandising engine 125 may return part type identifiers 200 that are filtered based on the seller identifier 612 in the listing 22 (e.g., request listing) identified in the request information. For example, the merchandising engine 125 may filter out part type identifiers 200 that do not match the seller identifier 612 in the request listing 22 to return listing identifiers that include compatible part type identifiers 200 and matching seller identifiers 612. In one embodiment, if the merchandising engine 125 identifies the predetermined number of top ranked part type identifiers 200 that are compatible as not being available from the same seller, then the merchandising engine 125 may attempt to return the next top ranked part type identifier 200 (e.g., second highest score). In one embodiment, the step described immediately above may be iterated until the merchandising engine 125 identifies the predetermined number of top ranked part type identifiers 200 that are compatible as further being available from the same seller or until the condition cannot be satisfied. In one embodiment, if there are no compatible part type identifiers 200 that are available from the same seller then the merchandising engine 125 may not return compatible listing identifiers and merchandising information may not be displayed. At operation 828, the communication module 106 may generate an interface based on the request listing 22 and the one or more compatible listings 22 and communicate the interface over the network 14 to the client machine 16. For example, the interface may include a user interface that includes merchandising information and seed information. The merchandising information may describe and illustrate a kit or set of vehicle parts (e.g., “ADDITIONAL”) that is generated based on the compatible listings 22 identified by the merchandising engine 125. The seed information may describe and illustrate the item that is described in the request listing 22. For example, the communication module 106 may generate a user interface as described in operation J and illustrated in FIG. 1A. At operation 830, the client machine 16 may receive and display the user interface.

FIG. 8B illustrates a method 840 to parse a listing 22, according to an embodiment. The method to parse a listing 22 corresponds to operation 808 on FIG. 8A. Returning to FIG. 8B, at operation 842, the processing module 124 may identify tokens 132 in the title 602 of the listing 22. For example, the processing module 124 may utilize the expansion table 128 and/or an expansion service to identify tokens 132 in the title 602 of the listing 22. At operation 844, the processing module 124 may identify the initial category 402 in the listing 22 as the category 402 currently being processed. At operation 846, the processing module 124 may identify the initial parts descriptor 164 in the category part information 20 based on the current category 402 as the parts descriptor 164 currently being processed. At operation 848, the processing module 124 may identify the initial token information 502 in the parts descriptor 164 being processed as the token information 502 currently being processed. Further, the token information 502 that is currently being processed includes the token 132 and the weight 504, both currently being processed. At decision operation 850, the processing module 124 may identify whether any of the tokens 132 in the title 602 match the token 132 being processed. Further, the processing module 124 may identify whether the any of the tokens 132 in the title 602 match any expansion tokens 134 of the token 132 being processed. For example, the processing module 124 may perform a look-up operation in the expansion table 128 to identify expansion tokens 134 based on the token 132 currently being processed and compare each of the expansion tokens 134 with the tokens 132 in the title 602. If the processing module 124 identifies a match with the token 132 that is currently being processed or any of its corresponding expansion tokens 134 then processing continues at operation 852. Otherwise, processing continues at decision operation 854. At operation 852, the processing module 124 may register the token weight 504 that is associated with the token 132 currently being processed. At decision operation 854, the processing module 124 may identify whether the parts descriptor 164 that is currently being processed includes another element of token information 502. If another element is included in the parts descriptor 164 then the processing module 124 advances to the next element of token information 502 before branching to decision operation 850. Otherwise, processing continues at decision operation 856. At decision operation 856, the processing module 124 may identify whether the parts information 400 that is currently being processed includes another parts descriptor 164. If another parts descriptor 164 is included in the parts information 400 then the processing module 124 advances to the next parts descriptor 164 before branching to operation 848. Otherwise, processing continues at decision operation 858. At decision operation 858, the processing module 124 may identify whether the listing 22 that was identified includes another category 402. If another category 402 is included in the listing 22 the processing module 124 advances to the next category 402 before branching to operation 846. Otherwise, the method 840 ends.

FIG. 8C illustrates a method 860, according to an embodiment, to generate part type scores. The method 860 to generate part type scores corresponds to operation 810 on FIG. 8A. Returning to FIG. 8C, at operation 862, the processing module 124 may identify the initial category 402 in the listing 22 as the category 402 currently being processed. At operation 864, the processing module 124 may identify the initial parts descriptor 164 in the category part information 20 based on the current category 402. For example, the processing module 124 may identify the initial parts descriptor 164 as the parts descriptor 164 currently being processed. At decision operation 866, the processing module 124 may identify whether a full match was identified. For example, the processing module 124 may identify a full match responsive to previously identifying all tokens 132 in the parts descriptor 164 as matching the tokens 132 in the title 602 of the listing 22. Recall that a match of an expansion token 134 that corresponds to a token 132 in the parts descriptor 164 constitutes a match for the token 132 in the parts descriptor 164. If the processing module 124 identifies the full match then the processing module 124 branches to operation 868. Otherwise, processing continues at decision operation 870. At operation 868, the processing module 124 may compute a full match score. For example, the processing module 124 may compute a full match score by summing all of the token weights 504 in the parts descriptor 164 that is currently being processed. At decision operation 870, the processing module 124 may identify whether a partial match was identified. For example, the processing module 124 may identify a partial match responsive to previously identifying at least one token 132 in the parts descriptor 164 as matching at least one token 132 in the title 602 of the listing 22. If a partial match was identified then the processing module 124 branches to operation 872. Otherwise, processing continues at operation 874. At operation 872, the processing module 124 may compute a partial match score. For example, the processing module 124 may compute a partial match score by summing all of the token weights 504 in the parts descriptor 164 that were registered (see operation 852 in FIG. 8B) to generate a matching sum, summing all of the token weights 504 in the parts descriptor 164 that were not registered to generate a non-matching sum, and subtracting the non-matching sum from the matching sum to compute the partial match score. At operation 874, the processing module 124 may count the tokens 132 that were identified as matching a token 132 in the title 602 of the listing 22. At decision operation 876, the processing module 124 may identify whether the parts information 400 that is currently being processed includes another parts descriptor 164. If another parts descriptor 164 is included in the parts information 400 for the category 402 that is currently being processed then the processing module 124 advances to the next parts descriptor 164 before branching to decision operation 866. Otherwise, processing continues at decision operation 878. At decision operation 878, the processing module 124 may identify whether the listing 22 that was identified includes another category 402. If another category 402 is included in the listing 22 then the processing module 124 advances to the next category 402 before branching to operation 864. Otherwise, the method 860 ends.

FIG. 8D illustrates a TABLE 2, according to an embodiment, that is generated to select a part type identifier 200. The TABLE 2 may be generated by the processing module 124 according to the method 860, as illustrated in FIG. 8C. TABLE 2 illustrates, from left to right, a column 881 including one or more categories 402 included in the listing 22 that is being processed, a column 883 including parts descriptors 164 according to the category 402, a column 885 to store full match scores (e.g., see operation 868 in FIG. 8C) according to parts descriptors 164 in categories 402, a column 887 to store partial match scores (e.g., see operation 872 in FIG. 8C) according to parts descriptors 164 in categories 402, and a column 889 to store matching token counts (e.g., see operation 874 in FIG. 8C) according to parts descriptors 164 in categories 402. It will be appreciated that TABLE 2 illustrates the results for two categories 402 however such results may be generated for additional categories 402 or a single category 402 according to the category 402 stored in the listing 22.

FIG. 8E illustrates a method 880 to select a part type identifier 200, according to an embodiment. The method 880 may be utilized to select a part type identifier 200 from multiple part type identifiers 200 based on the results in TABLE 2. At decision operation 882, the processing module 124 may identify whether a single full match was identified (e.g., see operation 868 in FIG. 8C). If a single full match was identified then the processing module 124 branches to operation 894. Otherwise, processing continues at decision operation 884. At decision operation 884, the processing module 124 may identify whether multiple full matches were identified (e.g., see operation 868 in FIG. 8C). If multiple full matches were identified then the processing module 124 branches to decision operation 886. Otherwise, processing continues at operation 888. At decision operation 886, the processing module 124 may identify whether the multiple full matches that were identified (e.g., see operation 868 in FIG. 8C) are further associated with the same token count (e.g., see operation 874 in FIG. 5C). If the immediately described condition is TRUE then the processing module 124 branches to decision operation 892. Otherwise, processing continues at operation 890. At operation 888, the processing module 124 may select a part type identifier 200 from a set of part type identifiers 200 that are respectively included in part descriptors 164 by identifying a highest partial match score form the set of partial match scores (e.g., see column 887, in TABLE 2, in FIG. 8D). At operation 890, the processing module 124 may select a part type identifier 200 from a set of part type identifiers 200 that are respectively included in part descriptors 164 by identifying a highest token count in the set of token counts (e.g., see column 889, in TABLE 2, in FIG. 8D). At operation 892, the processing module 124 may select a part type identifier 200 from a set of part type identifiers 200 that are respectively included in part descriptors 164 by identifying a highest full match score in the set of full match scores (e.g., see column 885, in TABLE 2, in FIG. 8D). At operation 892, the processing module 124 may select a part type identifier 200 from a set of part type identifiers 200 that are respectively included in part descriptors 164 according to the identified single full match score.

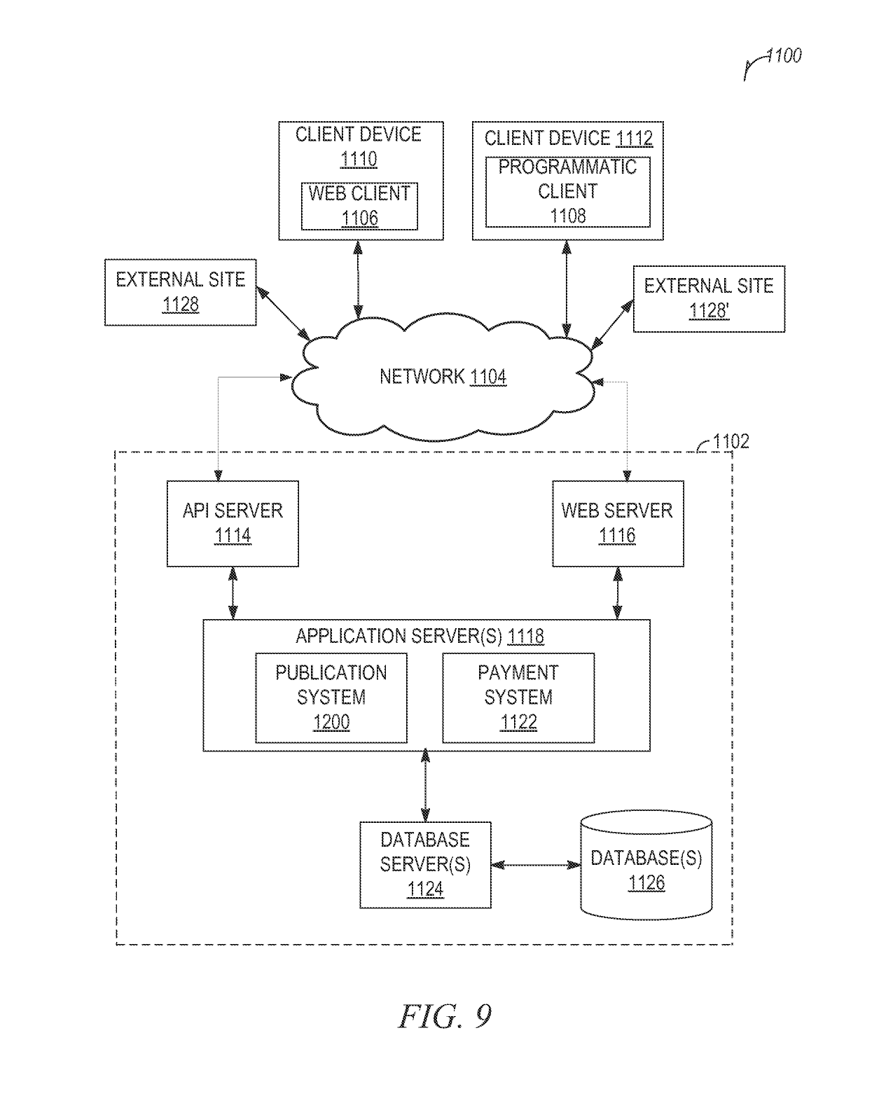

FIG. 9 illustrates a network architecture 1100, according to an embodiment. A networked system 1102, is coupled via a communication network 1104 (e.g., the Internet, wireless network, cellular network, or a wide area network (WAN)) to one or more client devices 1110 and 1112. The networked system 1102 corresponds to the network-based marketplace 12 in FIG. 1A, and the client devices 1110 and 1112 correspond to the client machines 16 in FIG. 1A, accordingly, the same or similar references have been used to indicate the same or similar features unless otherwise indicated. The networked system 1102 may be used to implement any of the methods described herein. FIG. 9 illustrates, for example, a web client 1106 operating via a browser (e.g., such as the INTERNET EXPLORER® browser developed by Microsoft® Corporation of Redmond, Wash. State), and a programmatic client 1108 executing on respective client devices 1110 and 1112. The network architecture 1100 may be utilized to execute any of the methods described in this document. The client devices 1110 and 1112 may comprise a mobile phone, desktop computer, laptop, or any other communication device that a user may utilize to access the networked system 1102. In some embodiments, the client device 1110 may comprise a display module (not shown) to display information (e.g., in the form of user interfaces). In further embodiments, the client device 1110 may comprise one or more of a touch screen, accelerometer, camera, microphone, and GPS device. The client devices 1110 and 1112 may be a device of a user that is used to perform a transaction involving digital goods within the networked system 1102. In one embodiment, the networked system 1102 is a network-based marketplace that manages digital goods, publishes publications comprising item listings of products available on the network-based marketplace 1102, and manages payments for these marketplace transactions. Additionally, external sites 1128, 1128′ may be sites coupled to networked system 1102 via network 1104. External sites 1128, 1128′ may be any desired system, including ecommerce systems.

An application program interface (API) server 1114 and a web server 1116 are coupled to, and provide programmatic and web interfaces respectively to, one or more application servers 1118. The application program interface (API) server 1114 and the web server 1116 may both invoke the communication module 106. The application server(s) 1118 host a publication system 1200 and a payment system 1122, each of which may comprise one or more modules, applications, or engines, and each of which may be embodied as hardware, software, firmware, or any combination thereof. The application servers 1118 are, in turn, coupled to one or more database servers 1124 facilitating access to one or more information storage repositories or database(s) 1126. In one embodiment, the databases 1126 are storage devices that store information to be posted (e.g., publications or listings 22) to the publication system 1200. The databases 1126 may also store digital goods information in accordance with example embodiments.

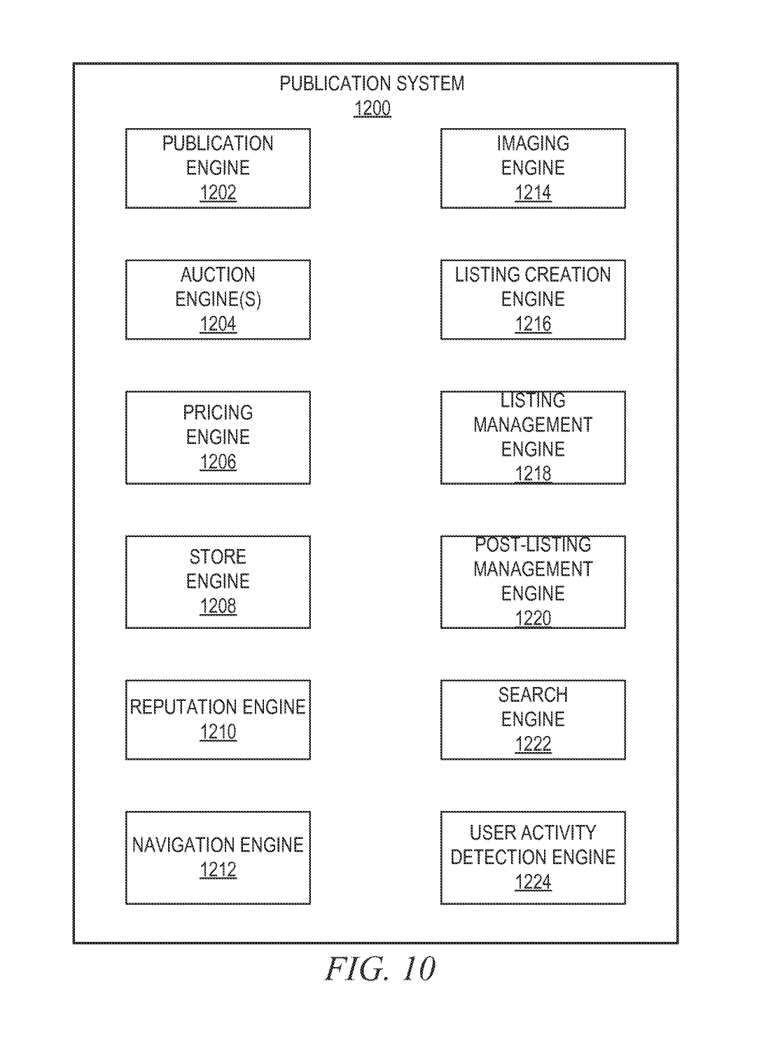

In example embodiments, the publication system 1200 publishes content on a network 1104 (e.g., Internet). As such, the publication system 1200 provides a number of publication and marketplace functions and services to users that access the networked system 1102. The publication system 1200 is discussed in more detail in connection with FIG. 10. In example embodiments, the publication system 1200 is discussed in terms of an online marketplace environment. However, it is noted that the publication system 1200 may be associated with a non-marketplace environment such as an informational (e.g., search engine) or social networking environment.

The payment system 1122 provides a number of payment services and functions to users. The payment system 1122 allows users to accumulate value (e.g., in a commercial currency, such as the U.S. dollar, or a proprietary currency, such as points, miles, or other forms of currency provide by a private entity) in their accounts, and then later to redeem the accumulated value for products (e.g., goods or services) that are made available via the publication system 1200 or elsewhere on the network 1104. The payment system 1122 also facilitates payments from a payment mechanism (e.g., a bank account, PayPal™, or credit card) for purchases of items via any type and form of a network-based marketplace 1102.

While the publication system 1200 and the payment system 1122 are shown in FIG. 9 to both form part of the networked system 1102, it will be appreciated that, in alternative embodiments, the payment system 1122 may form part of a payment service that is separate and distinct from the networked system 1102. Additionally, while the example network architecture 1100 of FIG. 9 employs a client-server architecture, a skilled artisan will recognize that the present disclosure is not limited to such an architecture. The example network architecture 1100 can equally well find application in, for example, a distributed or peer-to-peer architecture system. The publication system 1200 and payment system 1122 may also be implemented as standalone systems or standalone software programs operating under separate hardware platforms, which do not necessarily have networking capabilities.

Referring now to FIG. 10, an example block diagram illustrating multiple components that, in one embodiment, are provided within the publication system 1200 of the networked system 1102 is shown. In this embodiment, the publication system 1200 is a marketplace system where items (e.g., goods or services) may be offered for sale and that further implements the features described herein for interactive query generation and refinement. The items may comprise digital goods (e.g., currency, license rights). The publication system 1200 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 1126 via the one or more database servers 1124, as shown in FIG. 9.

Returning to FIG. 10, the publication system 1200 provides a number of publishing, listing, and price-setting mechanisms whereby a buyer may list (or publish information concerning) goods or services for sale, a buyer can express interest in or indicate a desire to purchase such goods or services, and a price 608 can be set for a transaction pertaining to the goods or services. To this end, the publication system 1200 may comprise at least one publication engine 1202 and one or more auction engines 1204 that support auction-format listing and price setting mechanisms (e.g., English, Dutch, Chinese, Double, Reverse auctions, etc.).

A pricing engine 1206 supports various price listing formats. One such format is a fixed-price listing format (e.g., the traditional classified advertisement-type listing 22 or a catalog listing 22). Another format comprises a buyout-type listing 22. Buyout-type listings 22 (e.g., the Buy-It-Now (BIN) technology developed by eBay Inc., of San Jose, Calif.) may be offered in conjunction with auction-format listings 22 and allow a buyer to purchase goods or services, which are also being offered for sale via an auction, for a fixed price 608 that is typically higher than a starting price 608 of an auction for an item.

A store engine 1208 allows a buyer to group listings 22 within a “virtual” store, which may be branded and otherwise personalized by and for the buyer. Such a virtual store may also offer promotions, incentives, and features that are specific and personalized to the buyer. In one example, the buyer may offer a plurality of items as Buy-It-Now items in the virtual store, offer a plurality of items for auction, or a combination of both.

A reputation engine 1210 allows users that transact, utilizing the networked system 1102, to establish, build, and maintain reputations. These reputations may be made available and published to potential trading partners. Because the publication system 1200 supports person-to-person trading between unknown entities, in accordance with one embodiment, users may otherwise have no history or other reference information whereby the trustworthiness and credibility of potential trading partners may be assessed. The reputation engine 1210 allows a user, for example through feedback provided by one or more other transaction partners, to establish a reputation within the network-based marketplace 1102 over time. Other potential trading partners may then reference the reputation for purposes of assessing credibility and trustworthiness.

Navigation of the network-based marketplace 1102 may be facilitated by a navigation engine 1212. For example, a browse module (not shown) of the navigation engine 1212 allows users to browse various category, catalog, or inventory data structures according to which listings 22 may be classified within the publication system 1200. Various other navigation applications within the navigation engine 1212 may be provided to supplement the browsing applications. For example, the navigation engine 1212 may include the communication module 106, as previously described.

In order to make listings 22 available via the networked system 1102 as visually informing and attractive as possible, the publication system 1200 may include an imaging engine 1214 that enables users to upload images 606 for inclusion within publications and to incorporate images 606 within viewed listings 22. The imaging engine 1214 may also receive image data from a user as a search query and utilize the image data to identify an item depicted or described by the image data.

A listing creation engine 1216 allows users (e.g., buyers) to conveniently author listings of items. In one embodiment, the listings 22 pertain to goods or services that a user (e.g., a buyer) wishes to transact via the publication system 1200. In other embodiments, a user may create a listing 22 that is an advertisement or other form of publication.

A listing management engine 1218 allows the users to manage such listings 22. Specifically, where a particular user has authored or published a large number of listings 22, the management of such listings 22 may present a challenge. The listing management engine 1218 provides a number of features (e.g., auto-relisting, inventory level monitors, etc.) to assist the user in managing such listings 22.

A post-listing management engine 1220 also assists users with a number of activities that typically occur post-listing. For example, the post-listing management engine 1220 may include the merchandising modules 108 to facilitate merchandising of items that are being offered for sale. Further for example, upon completion of a transaction facilitated by the one or more auction engines 1204, a buyer may wish to leave feedback regarding a particular seller. To this end, the post-listing management engine 1220 provides an interface to the reputation engine 1210 allowing the buyer to conveniently provide feedback regarding multiple sellers to the reputation engine 1210. Another post-listing action may be shipping of sold items whereby the post-listing management engine 1220 may assist in printing shipping labels, estimating shipping costs, and suggesting shipping carriers.

A search engine 1222 performs searches for publications in the networked system 1102 that match a query. In example embodiments, the search engine 1222 comprises a search module (not shown) that enables keyword searches of publications published via the publication system 1200. In a further embodiment, the search engine 1222 may take an image 606 received by the imaging engine 1214 as an input for conducting a search. The search engine 1222 takes the query input and determines a plurality of matches from the networked system 1102 (e.g., publications stored in the database 1126). It is noted that the functions of the search engine 1222 may be combined with the navigation engine 1212.

A user activity detection engine 1224 in FIG. 10 may monitor user activity during user sessions and detect a change in the level of user activity that, as discussed in more detail below, may predict that a user is about to make a purchase. The exact amount of change in the level of user activity may vary. A general guideline may be to monitor across multiple sessions and detect any significant increase over time (for example the activity level doubling or tripling in a short span). In one embodiment, when the user activity detection engine 1224 detects such a condition, the ecommerce system may make an intervention to provide content for display to the user in an effort to improve the probability that the user will make a purchase, and/or also to motive the user to make the purchase on the ecommerce system site instead of moving to a competitor site in search of a better purchase. Stated another way, activity over time and at different times before a purchase action provides an opportunity to personalize marketing to a user, based on time, by intervention as discussed above. Additional examples of including a temporal frame in that marketing personalization are discussed below.

Although the various components of the publication system 1200 have been defined in terms of a variety of individual modules and engines, a skilled artisan will recognize that many of the items can be combined or organized in other ways and that not all modules or engines need to be present or implemented in accordance with example embodiments. Furthermore, not all components of the publication system 1200 have been included in FIG. 10. In general, components, protocols, structures, and techniques not directly related to functions of exemplary embodiments (e.g., dispute resolution engine, loyalty promotion engine, personalization engines, etc.) have not been shown or discussed in detail. The description 604 given herein simply provides a variety of exemplary embodiments to aid the reader in an understanding of the systems and methods used herein.

### Data Structures

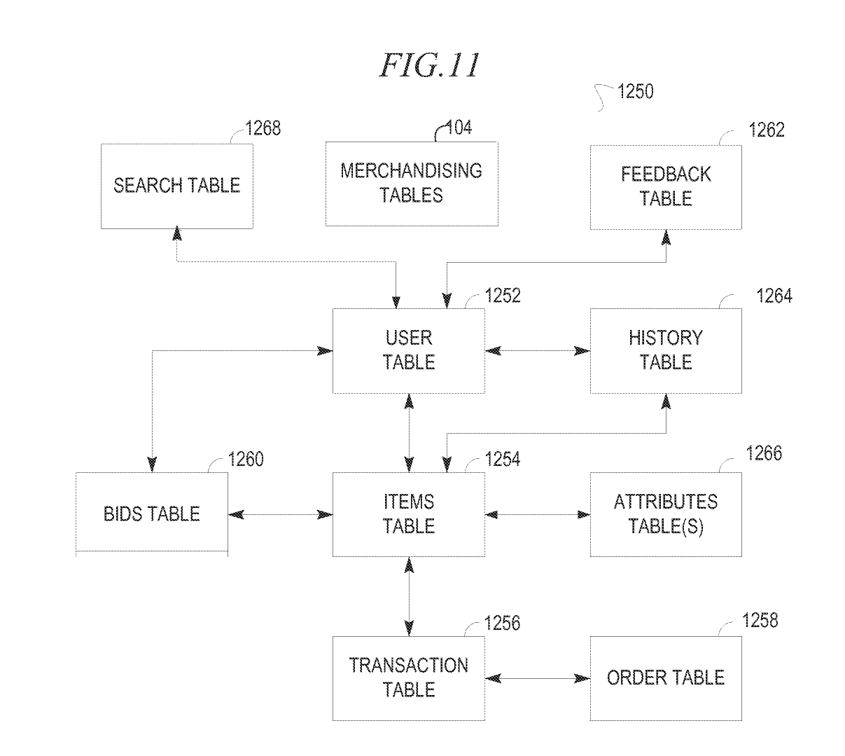

FIG. 11 is a high-level entity-relationship diagram, illustrating various tables 1250 that may be maintained within the databases 1126 of FIG. 9, and that are utilized by and support the publication system 1200 and payment system 1122, both of FIG. 9. A user table 1252 may contain a record for each of the registered users of the networked system 1102 (e.g., network-based marketplace 102) of FIG. 9. A user may operate as a seller, a buyer, or both, within the network-based marketplace 1102 (e.g., FIG. 9). In one example embodiment, a buyer may be a user that has accumulated value (e.g., commercial or proprietary currency), and is accordingly able to exchange the accumulated value for items that are offered for sale by the network-based marketplace 1102.

The tables 1250 may also include an items table 1254 (e.g., items table 24) in which item records (e.g., listings 22) are maintained for goods and services (e.g., items) that are available to be, or have been, transacted via the network-based marketplace 1102. Item records (e.g., listings 22) within the items table 1254 may furthermore be linked to one or more user records within the user table 1252, so as to associate a seller and one or more actual or potential buyers with an item record (e.g., listing 22).

A transaction table 1256 may contain a record for each transaction (e.g., a purchase or sale transaction or auction) pertaining to items for which records exist within the items table 1254.

An order table 1258 may be populated with order records, with each order record being associated with an order. Each order, in turn, may be associated with one or more transactions for which records exist within the transaction table 1256.

Bid records within a bids table 1260 may relate to a bid 610 received at the network-based marketplace 1102 in connection with an auction-format listing 22 supported by the auction engine(s) 1204 of FIG. 11. A feedback table 1262 may be utilized by one or more reputation engines 1210 of FIG. 11, in one example embodiment, to construct and maintain reputation information concerning users in the form of a feedback score. A history table 1264 may maintain a history of transactions to which a user has been a party. One or more attributes tables 1266 may record attribute information that pertains to items for which records exist within the items table 1254. Considering only a single example of such an attribute, the attributes tables 1266 may indicate a currency attribute associated with a particular item, with the currency attribute identifying the currency of a price 608 for the relevant item as specified by a seller. A search table 1268 may store search information that has been entered by a user (e.g., a buyer) who is looking for a specific type of listing 22. The tables 1250 may include merchandising tables 104, as previously described.

### Machine

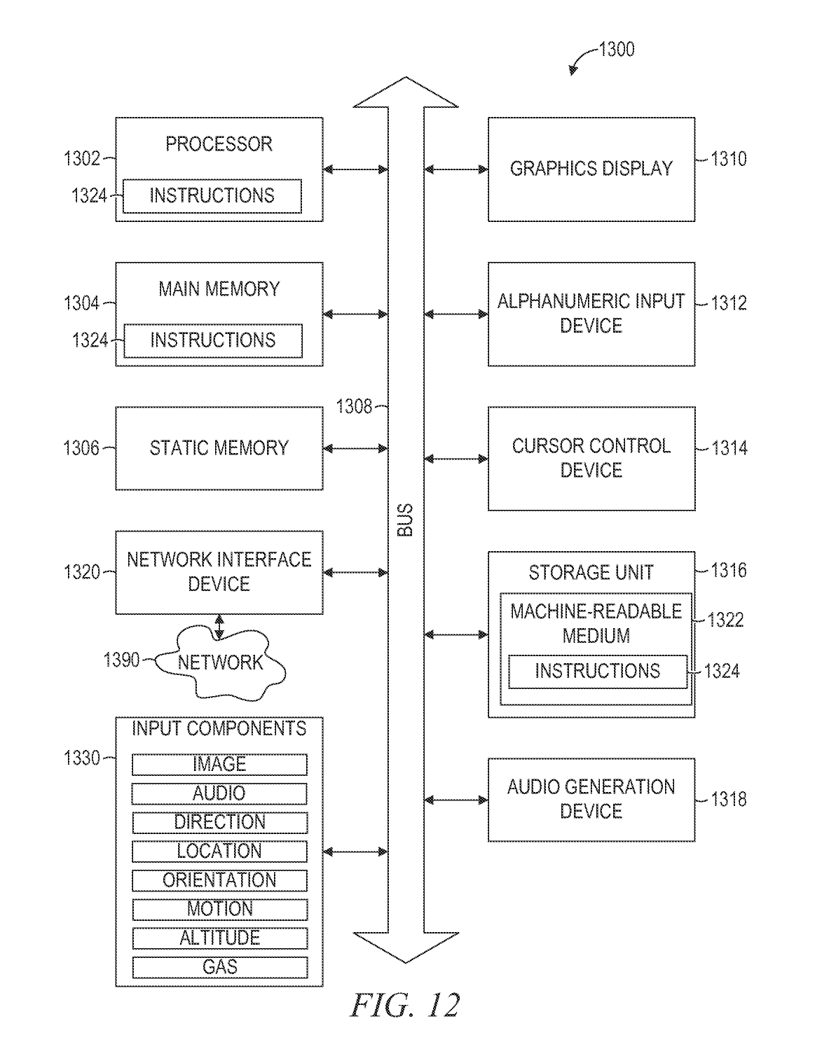

FIG. 12 is a block diagram illustrating components of a machine 1300, according to some example embodiments, able to read instructions 1324 from a machine-readable medium 1322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1300 in the example form of a computer system (e.g., a computer) within which the instructions 1324 (e.g., software, a program, an application, an applet, an app, or other executable code) for causing the machine 1300 to perform any one or more of the methodologies discussed herein may be executed, in whole or in part.

In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a distributed (e.g., peer-to-peer) network environment. The machine 1300 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine 1300 capable of executing the instructions 1324, sequentially or otherwise, that specify actions to be taken by that machine 1300. Further, while only a single machine 1300 is illustrated, the term “machine” shall also be taken to include any collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The processor 1302 may contain microcircuits that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein.

The machine 1300 may further include a graphics display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a cursor control device 1314 (e.g., a mouse, a touchpad, a trackball, a joystick, a motion sensor, an eye tracking device, or other pointing instrument), a storage unit 1316, an audio generation device 1318 (e.g., a sound card, an amplifier, a speaker, a headphone jack, or any suitable combination thereof), and a network interface device 1320.

The storage unit 1316 includes the machine-readable medium 1322 (e.g., a tangible and non-transitory machine-readable storage medium) on which are stored the instructions 1324 embodying any one or more of the methodologies or functions described herein. The instructions 1324 may also reside, completely or at least partially, within the main memory 1304, within the processor 1302 (e.g., within the processor's cache memory), or both, before or during execution thereof by the machine 1300. Accordingly, the main memory 1304 and the processor 1302 may be considered machine-readable media 1322 (e.g., tangible and non-transitory machine-readable media). The instructions 1324 may be transmitted or received over the network 1390 via the network interface device 1320. For example, the network interface device 1320 may communicate the instructions 1324 using any one or more transfer protocols (e.g., hypertext transfer protocol (HTTP)).

In some example embodiments, the machine 1300 may be a portable computing device, such as a smart phone or tablet computer, and have one or more additional input components 1330 (e.g., sensors or gauges). Examples of such input components 1330 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 1330 may be accessible and available for use by any of the modules described herein.

As used herein, the term “memory” refers to a machine-readable medium 1322 able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database 1126, or associated caches and servers) able to store instructions 1324. The term “machine-readable medium” shall also be taken to include any medium, or combination of multiple media, that is capable of storing the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1322 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1302 or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1302 or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 1302 configured by software to become a special-purpose processor, the general-purpose processor 1302 may be configured as respectively different special-purpose processors (e.g., comprising different hardware modules) at different times. Software (e.g., a software module) may accordingly configure one or more processors 1302, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1302 that are temporarily configured (e.g., by software) or permanently configured to perform the relevant operations. Whether temporarily or permanently configured, such processors 1302 may constitute processor-implemented modules that operate to perform one or more operations or functions described herein. As used herein, “processor-implemented module” refers to a hardware module implemented using one or more processors 1302.

Similarly, the methods described herein may be at least partially processor-implemented, a processor 1302 being an example of hardware. For example, at least some of the operations of a method may be performed by one or more processors 1302 or processor-implemented modules. As used herein, “processor-implemented module” refers to a hardware module in which the hardware includes one or more processors 1302. Moreover, the one or more processors 1302 may also operate to support performance of the relevant operations in a “cloud computing” environment or as a “software as a service” (SaaS). For example, at least some of the operations may be performed by a group of computers (as examples of machines 1300 including processors 1302), with these operations being accessible via a network 1390 (e.g., the Internet) and via one or more appropriate interfaces (e.g., an application program interface (API)).

The performance of certain operations may be distributed among the one or more processors 1302, not only residing within a single machine 1300, but deployed across a number of machines 1300. In some example embodiments, the one or more processors 1302 or processor-implemented modules may be located in a single geographic location (e.g., within a home environment, an office environment, or a server farm). In other example embodiments, the one or more processors 1302 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 1300. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 1300 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

We claim:

1. A system comprising:
a communication module, implemented using one or more processors, that is configured to receive listing information, over a network, from a client machine, the listing information describing a part that is being offered for sale on a network-based marketplace including a plurality of categories including a first category and a second category, the listing information including a title and a first category;
a processing module, implemented using one or more processors, that is configured to store the listing information in a first listing in the first category,
parse the title of the first listing to identify a first plurality of tokens and to identify whether the first plurality of tokens includes at least one token that matches at least one token in a second plurality of tokens in a plurality of parts descriptors, the plurality of parts descriptors describe parts that are associated with the first category but not a second category,
generate a plurality of scores based on the first plurality of tokens and the plurality of parts descriptors, the plurality of parts descriptors including a first parts descriptor and a second parts descriptor,
select a first part type identifier from a plurality of part type identifiers based on the plurality of scores, the first parts descriptor including a first parts type identifier, the second parts descriptor not including the first part identifier,
register the first listing with the first parts type identifier; and
a merchandising engine to associate at least one listing with the first listing based on the first parts type identifier.

2. The system of claim 1, wherein the plurality of categories includes listings that describe items that are offered for sale on the network-based marketplace.

3. The system of claim 1, wherein the first plurality of tokens includes a second plurality of tokens that match a set of tokens that are included in the plurality of parts descriptors.

4. The system of claim 1, wherein the processing module is further configured to register a token weight that is computed based on a previous sampling of listings in the first category.

5. The system of claim 1, wherein the first parts descriptor includes a first token and wherein the processing module is further configured to register a token weight of one based on the first token matching the first category.

6. The system of claim 1, wherein the first parts descriptor includes a third plurality of tokens that includes a fourth plurality of tokens that match the title of the listing, and wherein the second plurality of tokens matches the fourth plurality of tokens.

7. The system of claim 6, wherein the fourth plurality of tokens are respectively associated with token weights, and wherein the processing module is further configured to sum the token weights to generate a score.

8. The system of claim 7, wherein the processing module is further configured to select the first parts type identifier in response to an identification of a score as a highest score.

9. The system of claim 7, wherein the processing module is further configured to select the first parts type identifier in response to an identification of the first parts type identifier as being associated with a highest number of tokens that match the title.

10. A method comprising:
receiving listing information, over a network, from a client machine, the listing information describing a part that is being offered for sale on a network-based marketplace including a plurality of categories including a first category and a second category, the listing information including a title and the first category;
storing the listing information in a first listing in the first category;
parsing the title of the first listing to identify a first plurality of tokens and to identify whether the first plurality of tokens includes at least one token that matches at least one token in a second plurality of tokens in a plurality of parts descriptors, the plurality of parts descriptors describing parts and being associated with the first category but not the second category;
generating a plurality of scores based on the first plurality of tokens and the plurality of parts descriptors, the plurality of parts descriptors including a first parts descriptor and a second parts descriptor;
selecting a first part type identifier from a plurality of part type identifiers based on the plurality of scores, the first parts descriptor including the first part type identifier, the second parts descriptor not including the first part type identifier;
registering the first listing with the first parts type identifier, and
merchandising at least one listing with the first listing based on the first parts type identifier.

11. The method of claim 10, wherein the plurality of categories respectively includes listings describing items that are being offered for sale on the network-based marketplace.

12. The method of claim 10, wherein the first plurality of tokens includes the second plurality of tokens that match a set of tokens that are included in the plurality of parts descriptors.

13. The method of claim 10, wherein the parsing the title of the listing includes registering a token weight that is computed based on a previous sampling of listings in the first category.

14. The method of claim 10, wherein the first parts descriptor includes a first token and wherein the parsing the title of the listing includes registering a token weight of one based on the first token matching the first category.

15. The method of claim 10, wherein the first parts descriptor includes a third plurality of tokens that includes a fourth plurality of tokens that match the title of the listing, and wherein the second plurality of tokens matches the fourth plurality of tokens.

16. The method of claim 15, wherein the fourth plurality of tokens are respectively associated with token weights, and wherein the generating the plurality of scores includes summing the token weights to generate a score.

17. The method of claim 16, wherein the selecting the part type identifier includes selecting the first part type identifier responsive to identifying the score as being the highest score.

18. The method of claim 16, wherein the selecting the part type identifier includes selecting the first part type identifier responsive to identifying the first part type identifier as being associated with a highest number of tokens that matched the title.

19. One or more machine-readable hardware storage devices having no transitory signals storing a set of instructions that, when executed by one or more processors of a machine, cause the machine to perform operations comprising:
receiving listing information, over a network, from a client machine, the listing information describing a part that is being offered for sale on a network-based marketplace including a plurality of categories including a first category and a second category, the listing information including a title and the first category;
storing the listing information in a first listing in the first category;
parsing the title of the first listing to identify a first plurality of tokens and to identify whether the first plurality of tokens includes at least one token that matches at least one token in a second plurality of tokens in a plurality of parts descriptors, the plurality of parts descriptors describing parts and being associated with the first category but not the second category;
generating a plurality of scores based on the first plurality of tokens and the plurality of parts descriptors, the plurality of parts descriptors including a first parts descriptor and a second parts descriptor;
selecting a first part type identifier from a plurality of part type identifiers based on the plurality of scores, the first parts descriptor including the first part type identifier, the second parts descriptor not including the first part type identifier;
registering the first listing with the first parts type identifier, and
merchandising at least one listing with the first listing based on the first parts type identifier.

20. The one or more machine-readable hardware storage devices of claim 19, wherein the first parts descriptor includes a third plurality of tokens that includes a fourth plurality of tokens that match the title of the listing, and wherein the second plurality of tokens matches the fourth plurality of tokens.
